(19) United States
(12) Patent Application Publication
(10) Pub. No.: US 2026/0110883 A1
(43) Pub. Date: Apr. 23, 2026

(54) OPTICAL SYSTEM LENS ASSEMBLY, IMAGE CAPTURING UNIT AND ELECTRONIC DEVICE

(71) Applicant: LARGAN INDUSTRIAL OPTICS CO., LTD., Taichung City (TW)

(72) Inventors: Shiu Sheng LI, Taichung City (TW); Cheng-Yu TSAI, Taichung City (TW)

(73) Assignee: LARGAN INDUSTRIAL OPTICS CO., LTD., Taichung City (TW)

(21) Appl. No.: 18/981,802

(22) Filed: Dec. 16, 2024

(30) Foreign Application Priority Data
Oct. 18, 2024 (TW) 113139758

(51) Int. Cl. G02B 13/00; G02B 9/62

(52) U.S. Cl. CPC G02B 13/0045; G02B 9/62

(57) ABSTRACT

An optical system lens assembly includes six lens elements which are, in order from an object side to an image side along an optical path: a first lens element, a second lens element, a third lens element, a fourth lens element, a fifth lens element and a sixth lens element. Each of the six lens elements has an object-side surface facing toward the object side and an image-side surface facing toward the image side. The first lens element has negative refractive power. The object-side surface of the second lens element is concave in a paraxial region thereof. The third lens element has positive refractive power. The fourth lens element has positive refractive power. The object-side surface of the fifth lens element is concave in a paraxial region thereof. The sixth lens element has negative refractive power.

### RELATED APPLICATIONS

This application claims priority to Taiwan Application 113139758, filed on Oct. 18, 2024, which is incorporated by reference herein in its entirety.

### BACKGROUND

### Technical Field

The present disclosure relates to an optical system lens assembly, an image capturing unit and an electronic device, more particularly to an optical system lens assembly and an image capturing unit applicable to an electronic device.

### Description of Related Art

With the development of semiconductor manufacturing technology, the performance of image sensors has improved, and the pixel size thereof has been scaled down. Therefore, featuring high image quality becomes one of the indispensable features of an optical system nowadays.

Furthermore, due to the rapid changes in technology, electronic devices equipped with optical systems are trending towards multi-functionality for various applications, and therefore the functionality requirements for the optical systems have been increasing. However, it is difficult for a conventional optical system to obtain a balance among the requirements such as high image quality, low sensitivity, a proper aperture size, miniaturization and a desirable field of view.

### SUMMARY

According to one aspect of the present disclosure, an optical system lens assembly includes six lens elements. The six lens elements are, in order from an object side to an image side along an optical path, a first lens element, a second lens element, a third lens element, a fourth lens element, a fifth lens element and a sixth lens element. Each of the six lens elements has an object-side surface facing toward the object side and an image-side surface facing toward the image side.

Preferably, the first lens element has negative refractive power. Preferably, the object-side surface of the second lens element is concave in a paraxial region thereof. Preferably, the third lens element has positive refractive power. Preferably, the fourth lens element has positive refractive power. Preferably, the object-side surface of the fifth lens element is concave in a paraxial region thereof. Preferably, the sixth lens element has negative refractive power.

A central thickness of the second lens element is CT2, and an axial distance between the first lens element and the second lens element is T12; using a wavelength of helium d-line as a reference wavelength for the optical system lens assembly, an Abbe number of the fifth lens element is V5d, an Abbe number of the sixth lens element is V6d, a focal length of the fifth lens element is f5d, and a focal length of the sixth lens element is f6d; and the following conditions are preferably satisfied:

$$20. < V 5 d + V 6 d < 65. ;$$

$$1.2 < CT 2 / T 12 < 4. ; and \vert f 6 d / f 5 d \vert < 3.5 .$$

According to another aspect of the present disclosure, an optical system lens assembly includes six lens elements. The six lens elements are, in order from an object side to an image side along an optical path, a first lens element, a second lens element, a third lens element, a fourth lens element, a fifth lens element and a sixth lens element. Each of the six lens elements has an object-side surface facing toward the object side and an image-side surface facing toward the image side.

Preferably, the first lens element has negative refractive power. Preferably, the object-side surface of the second lens element is concave in a paraxial region thereof. Preferably, the third lens element has positive refractive power. Preferably, the fourth lens element has positive refractive power. Preferably, the object-side surface of the fifth lens element is concave in a paraxial region thereof. Preferably, the sixth lens element has negative refractive power. Preferably, the object-side surface of the sixth lens element is convex in a paraxial region thereof. Preferably, the image-side surface of the sixth lens element is concave in a paraxial region thereof. Preferably, at least one of the object-side surface and the image-side surface of the sixth lens element has at least one inflection point.

Using a wavelength of helium d-line as a reference wavelength for the optical system lens assembly, an Abbe number of the first lens element is V1d, an Abbe number of the fifth lens element is V5d, an Abbe number of the sixth lens element is V6d, and the following conditions are preferably satisfied:

$$20. < V 5 d + V 6 d < 55. ; and 10. < V 1 d < 35. .$$

According to another aspect of the present disclosure, an optical system lens assembly includes six lens elements. The six lens elements are, in order from an object side to an image side along an optical path, a first lens element, a second lens element, a third lens element, a fourth lens element, a fifth lens element and a sixth lens element. Each of the six lens elements has an object-side surface facing toward the object side and an image-side surface facing toward the image side.

Preferably, the first lens element has negative refractive power. Preferably, the object-side surface of the second lens element is concave in a paraxial region thereof. Preferably, the third lens element has positive refractive power. Preferably, the image-side surface of the third lens element is convex in a paraxial region thereof. Preferably, the fourth lens element has positive refractive power. Preferably, the object-side surface of the fifth lens element is concave in a paraxial region thereof. Preferably, the sixth lens element has negative refractive power. Preferably, the object-side surface of the sixth lens element is convex in a paraxial region thereof. Preferably, the image-side surface of the sixth lens element is concave in a paraxial region thereof. Preferably, at least one of the object-side surface and the image-side surface of the sixth lens element has at least one inflection point.

A maximum among axial distances between each of all adjacent lens elements of the optical system lens assembly is MaxAT, and a central thickness of the fifth lens element is CT5; using a wavelength of helium d-line as a reference wavelength for the optical system lens assembly, an Abbe number of the fifth lens element is V5d, and an Abbe number of the sixth lens element is V6d; and the following conditions are preferably satisfied:

$$20. < V 5 d + V 6 d < 70. ; and 0.1 < Max AT / CT 5 < 1.4 .$$

According to another aspect of the present disclosure, an image capturing unit includes one of the aforementioned optical system lens assemblies and an image sensor, wherein the image sensor is disposed on an image surface of the optical system lens assembly.

According to another aspect of the present disclosure, an electronic device includes the aforementioned image capturing unit.

### BRIEF DESCRIPTION OF THE DRAWINGS

The disclosure can be better understood by reading the following detailed description of the embodiments, with reference made to the accompanying drawings as follows:

FIG. 1 is a schematic view of an image capturing unit according to the 1st embodiment of the present disclosure;

FIG. 2 shows spherical aberration curves, astigmatic field curves and a distortion curve of the image capturing unit according to the 1st embodiment;

FIG. 3 is a schematic view of an image capturing unit according to the 2nd embodiment of the present disclosure;

FIG. 4 shows spherical aberration curves, astigmatic field curves and a distortion curve of the image capturing unit according to the 2nd embodiment;

FIG. 5 is a schematic view of an image capturing unit according to the 3rd embodiment of the present disclosure;

FIG. 6 shows spherical aberration curves, astigmatic field curves and a distortion curve of the image capturing unit according to the 3rd embodiment;

FIG. 7 is a schematic view of an image capturing unit according to the 4th embodiment of the present disclosure;

FIG. 8 shows spherical aberration curves, astigmatic field curves and a distortion curve of the image capturing unit according to the 4th embodiment;

FIG. 9 is a schematic view of an image capturing unit according to the 5th embodiment of the present disclosure;

FIG. 10 shows spherical aberration curves, astigmatic field curves and a distortion curve of the image capturing unit according to the 5th embodiment;

FIG. 11 is a schematic view of an image capturing unit according to the 6th embodiment of the present disclosure;

FIG. 12 shows spherical aberration curves, astigmatic field curves and a distortion curve of the image capturing unit according to the 6th embodiment;

FIG. 13 is a schematic view of an image capturing unit according to the 7th embodiment of the present disclosure;

FIG. 14 shows spherical aberration curves, astigmatic field curves and a distortion curve of the image capturing unit according to the 7th embodiment;

FIG. 15 is a schematic view of an image capturing unit according to the 8th embodiment of the present disclosure;

FIG. 16 shows spherical aberration curves, astigmatic field curves and a distortion curve of the image capturing unit according to the 8th embodiment;

FIG. 17 is a perspective view of an image capturing unit according to the 9th embodiment of the present disclosure;

FIG. 18 is one perspective view of an electronic device according to the 10th embodiment of the present disclosure;

FIG. 19 is another perspective view of the electronic device in FIG. 18;

FIG. 20 is a block diagram of the electronic device in FIG. 18;

FIG. 21 is one schematic view of an electronic device according to the 11th embodiment of the present disclosure;

FIG. 22 is another schematic view of the electronic device in FIG. 21;

FIG. 23 is one perspective view of an electronic device according to the 12th embodiment of the present disclosure;

FIG. 24 is a perspective view of an electronic device according to the 13th embodiment of the present disclosure;

FIG. 25 is a side view of the electronic device in FIG. 24;

FIG. 26 is a top view of the electronic device in FIG. 24;

FIG. 27 is a perspective view of an electronic device according to the 14th embodiment of the present disclosure;

FIG. 28 shows a schematic view of Y1R1d and Y3R2d according to the 1st embodiment of the present disclosure;

FIG. 29 shows a schematic view of CRAd according to the present disclosure;

FIG. 30 shows a schematic view of inflection points on lens surfaces and critical points on lens surfaces according to the 1st embodiment of the present disclosure;

FIG. 31 shows a schematic view of a configuration of one light-folding element in an optical system lens assembly according to one embodiment of the present disclosure;

FIG. 32 shows a schematic view of another configuration of one light-folding element in an optical system lens assembly according to one embodiment of the present disclosure; and

FIG. 33 shows a schematic view of a configuration of two light-folding elements in an optical system lens assembly according to one embodiment of the present disclosure.

### DETAILED DESCRIPTION

An optical system lens assembly includes six lens elements. The six lens elements are, in order from an object side to an image side along an optical path, a first lens element, a second lens element, a third lens element, a fourth lens element, a fifth lens element and a sixth lens element. Each of the six lens elements of the optical system lens assembly has an object-side surface facing toward the object side and an image-side surface facing toward the image side.

The first lens element can have negative refractive power. Therefore, it is favorable for increasing the field of view of the optical system lens assembly and enlarging the size of the image surface.

The second lens element can have positive refractive power. Therefore, it is favorable for assisting in balancing the refractive power of the first lens element while correcting off-axis aberrations. The object-side surface of the second lens element can be concave in a paraxial region thereof. Therefore, it is favorable for adjusting the surface shape and refractive power of the second lens element to improve central image quality.

The third lens element can have positive refractive power. Therefore, it is favorable for converging light to reduce the size of the optical system lens assembly. The image-side surface of the third lens element can be convex in a paraxial region thereof. Therefore, it is favorable for controlling the direction of peripheral light in the third lens element to prevent insufficient deflection in the peripheral regions, thereby ensuring effective light convergence.

The fourth lens element can have positive refractive power. Therefore, it is favorable for converging light and effectively controlling the optical path, and achieving a balance between the field of view and size distribution.

The fifth lens element can have positive refractive power. Therefore, it is favorable for balancing the refractive power of the fourth lens element and the sixth lens element, and enhancing light focusing quality across all fields of view on the image surface and reducing aberrations. The object-side surface of the fifth lens element can be concave in a paraxial region thereof. Therefore, it is favorable for balancing the incident angle of large-angle light entering the fifth lens element to prevent light divergence. The image-side surface of the fifth lens element can be convex in a paraxial region thereof. Therefore, it is favorable for adjusting the refraction direction of light in the fifth lens element to enlarge the image surface.

The sixth lens element can have negative refractive power. Therefore, it is favorable for balancing the refractive power of image-side lens element and reducing the back focal length. The object-side surface of the sixth lens element can be convex in a paraxial region thereof. Therefore, it is favorable for reducing field curvature and simultaneously shortening the back focal length. The image-side surface of the sixth lens element can be concave in a paraxial region thereof. Therefore, it is favorable for shortening the back focal length.

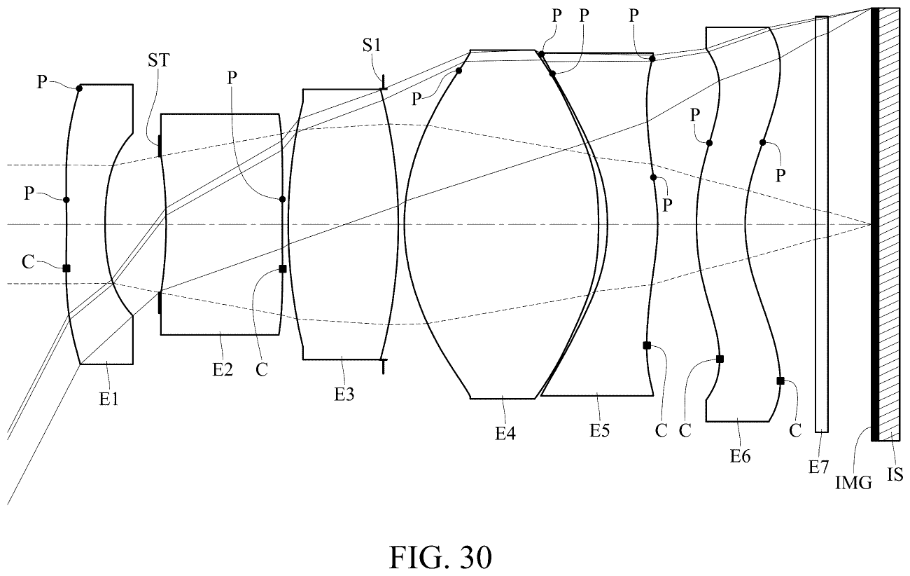

At least one of the object-side surface and the image-side surface of the sixth lens element can have at least one inflection point. Therefore, it is favorable for enhancing the ability of the sixth lens element to correct peripheral image aberrations. Please refer to FIG. 30, which shows a schematic view of the inflection points P on the lens surfaces according to the 1st embodiment of the present disclosure. In FIG. 30, the image-side surface of the second lens element E2, the object-side surface of the fourth lens element E4, and the object-side surface and the image-side surface of the sixth lens element E6 each have one inflection point P, and the object-side surface of the first lens element E1, and the object-side surface and the image-side surface of the fifth lens element E5 each have two inflection points P. The 1st embodiment of the present disclosure shown in FIG. 30 is only exemplary. Each of the lens elements in various embodiments of the present disclosure can have one or more inflection points.

At least one of the object-side surface and the image-side surface of the sixth lens element can have at least one critical point in an off-axis region thereof. Therefore, it is favorable for adjusting the angle of light incidence on the image surface and controlling the angle of peripheral light to enhance peripheral illuminance and image quality on the image surface. Please refer to FIG. 30, which shows a schematic view of the critical points C on the lens surfaces according to the 1st embodiment of the present disclosure. In FIG. 30, the object-side surface of the first lens element E1, the image-side surface of the second lens element E2, the image-side surface of the fifth lens element E5, and the object-side surface and the image-side surface of the sixth lens element E6 each have one critical point C in an off-axis region thereof. The 1st embodiment of the present disclosure shown in FIG. is only exemplary. Each of the lens elements in various embodiments of the present disclosure can have one or more critical points in an off-axis region thereof. According to the present disclosure, at least one of the six lens elements of the optical system lens assembly can be made of glass material. Therefore, it is favorable for effectively reducing sensitivity to environmental factors by using glass lens element(s), thereby providing high stability across various conditions, and it is also favorable for effectively resisting humid environments and preventing surface scratches, thereby significantly enhancing the lifespan of electronic products.

According to the present disclosure, some optical parameters can be measured at a wavelength of helium d-line (587.6 nm) by using the wavelength of helium d-line as a reference wavelength for the optical system lens assembly. More specifically, the optical system lens assembly of the present disclosure is applicable to a wide range of wavelength of light, for example, within a wavelength range of 600 nm to 1000 nm. However, during the design of the optical system lens assembly of the present disclosure, one or more optical parameters of the optical system lens assembly may be determined or measured by using an incident light source having the wavelength of helium d-line. Moreover, the optical system lens assembly is applicable to the infrared wavelength range, for example, within a wavelength range of 750 nm to 1000 nm, offering high image quality, a miniaturized design, and image recognition capabilities, suitable for various applications, including industrial inspection, surveillance, automotive systems, drones, dynamic eye tracking, and positioning. Moreover, the optical system lens assembly is also applicable to a wavelength range of 850 nm to 1000 nm.

Using a wavelength of helium d-line as a reference wavelength for the optical system lens assembly, an Abbe number of the fifth lens element is V5d, an Abbe number of the sixth lens element is V6d, and the following condition can be satisfied: 20.0<V5d+V6d<70.0. Therefore, it is favorable for effectively correcting the focal position across different wavelengths, especially in the infrared range, to prevent image overlap and enhance image resolution. Moreover, the following condition can also be satisfied: 20.0<V5d+V6d<65.0. Moreover, the following condition can also be satisfied: 20.0<V5d+V6d<55.0. Moreover, the following condition can also be satisfied: 30.0<V5d+V6d<50.0. Moreover, the following condition can also be satisfied: 33.0<V5d+V6d<48.0. Moreover, the following condition can also be satisfied: 35.8≤V5d+V6d≤45.2. According to the present disclosure, the Abbe number Vd of one lens element is obtained from the following equation: Vd=(Nd−1)/(NF−NC), wherein Nd is the refractive index of said lens element at the wavelength of helium d-line (587.6 nm), NF is the refractive index of said lens element at the wavelength of hydrogen F-line (486.1 nm), and NC is the refractive index of said lens element at the wavelength of hydrogen C-line (656.3 nm). In the present disclosure, when parameters (e.g., V5d and V6d) of the optical system lens assembly are defined with a wavelength of helium d-line as a reference wavelength, these parameters are measured at the wavelength of helium d-line as a reference wavelength.

When a central thickness of the second lens element is CT2, and an axial distance between the first lens element and the second lens element is T12, the following condition can be satisfied: 1.20<CT2/T12<4.00. Therefore, it is favorable for balancing the distance between the first lens element and the second lens element and the central thickness of the second lens element to increase space utilization and reduce manufacturing tolerances. Moreover, the following condition can also be satisfied: 1.40<CT2/T12<3.00. Moreover, the following condition can also be satisfied: 1.45<CT2/T12<2.60. Moreover, the following condition can also be satisfied: 1.57≤CT2/T12≤2.32.

Using the wavelength of helium d-line as the reference wavelength for the optical system lens assembly, a focal length of the fifth lens element is f5d, a focal length of the sixth lens element is f6d, and the following condition can be satisfied: |f6d/f5d|<3.50. Therefore, it is favorable for balancing the refractive power of the fifth lens element and the sixth lens element to balance the convergence or divergence of light on the image side to improve light-gathering quality across the entire field of view. Moreover, the following condition can also be satisfied: 0.05<|f6d/f5d|<2.00. Moreover, the following condition can also be satisfied: 0.19≤|f6d/f5d|≤1.70. Moreover, the following condition can also be satisfied: 0.10<|f6d/f5d|<1.00. According to the present disclosure, a focal length fi of one lens element is obtained from the following equation: 1/fi=(Ni−1)×(1/Ri1−1/Ri2+CTi×(Ni−1)/(Ri1×Ri2×Ni)), wherein Ni is the refractive index of said lens element, Ri1 is the curvature radius of the object-side surface of said lens element, Ri2 is the curvature radius of the image-side surface of said lens element, and CTi is the central thickness of said lens element.

Using the wavelength of helium d-line as the reference wavelength for the optical system lens assembly, an Abbe number of the first lens element is V1d, and the following condition can be satisfied: 10.0<V1d<35.0. Therefore, it is favorable for adjusting the lens material distribution to reduce size and correct aberrations, particularly for applications in the infrared wavelength range. Moreover, the following condition can also be satisfied: 13.0<V1d<30.0. Moreover, the following condition can also be satisfied: 15.0<V1d<27.0. Moreover, the following condition can also be satisfied: 19.5≤V1d≤25.7.

When a maximum among axial distances between each of all adjacent lens elements of the optical system lens assembly is MaxAT, and a central thickness of the fifth lens element is CT5, the following condition can be satisfied: 0.10<MaxAT/CT5<1.40. Therefore, it is favorable for adjusting the ratio of the maximum axial distance of adjacent lens elements to the central thickness of the fifth lens element to achieve a balance between assembly tolerance and manufacturability for the fifth lens element. Moreover, the following condition can also be satisfied: 0.20<MaxAT/CT5<1.25. Moreover, the following condition can also be satisfied: 0.36≤MaxAT/CT5≤1.22. Moreover, the following condition can also be satisfied: 0.30<MaxAT/CT5<1.00.

Using the wavelength of helium d-line as the reference wavelength for the optical system lens assembly, an axial distance between the object-side surface of the first lens element and an image surface is TLd, a focal length of the optical system lens assembly is fd, and the following condition can be satisfied: 3.00<TLd/fd<5.00. Therefore, it is favorable for balancing the total track length and field of view of the optical system lens assembly to facilitate the formation of wide-angle characteristics. Moreover, the following condition can also be satisfied: 3.40<TLd/fd<4.50. Moreover, the following condition can also be satisfied: 3.61≤TLd/fd≤4.12. Said axial distance between the object-side surface of the first lens element and the image surface can refer to the total track length of the optical system lens assembly.

When a curvature radius of the object-side surface of the third lens element is R5, and a curvature radius of the image-side surface of the third lens element is R6, the following condition can be satisfied: −0.50<(R5+R6)/(R5−R6)<1.50. Therefore, it is favorable for effectively balancing the curvature radii of the object-side surface and the image-side surface of the third lens element to maintain a similar degree of curvature, thereby reducing manufacturing difficulty and improving yield. Moreover, the following condition can also be satisfied: −0.30<(R5+R6)/(R5−R6)<1.00. Moreover, the following condition can also be satisfied: −0.15<(R5+R6)/(R5−R6)<0.80.

When a sum of axial distances between each of all adjacent lens elements of the optical system lens assembly is ΣAT, and a sum of central thicknesses of all lens elements of the optical system lens assembly is ΣCT, the following condition can be satisfied: 0.05<ΣAT/ΣCT<0.45. Therefore, it is favorable for adjusting the distribution of lens elements and achieving a balance between central thicknesses of lens elements and axial distances between adjacent lens elements to increase space utilization efficiency. Moreover, the following condition can also be satisfied: 0.08<ΣAT/ΣCT<0.35. Moreover, the following condition can also be satisfied: 0.10<ΣAT/ΣCT<0.28.

When a central thickness of the third lens element is CT3, and the central thickness of the fifth lens element is CT5, the following condition can be satisfied: 0.10<CT5/CT3<1.80. Therefore, it is favorable for balancing the central thickness of the third lens element and the central thickness of the fifth lens element to balance the spatial arrangement between object-side lens group and image-side lens group. Moreover, the following condition can also be satisfied: 0.80<CT5/CT3<2.00.

Using the wavelength of helium d-line as the reference wavelength for the optical system lens assembly, half of a maximum field of view of the optical system lens assembly is HFOVd, and the following condition can be satisfied: 50.0 degrees<HFOVd<75.0 degrees. Therefore, it is favorable for the optical system lens assembly to achieve a larger field of view and expand the image capture range. Moreover, the following condition can also be satisfied: 58.0 degrees<HFOVd<70.0 degrees.

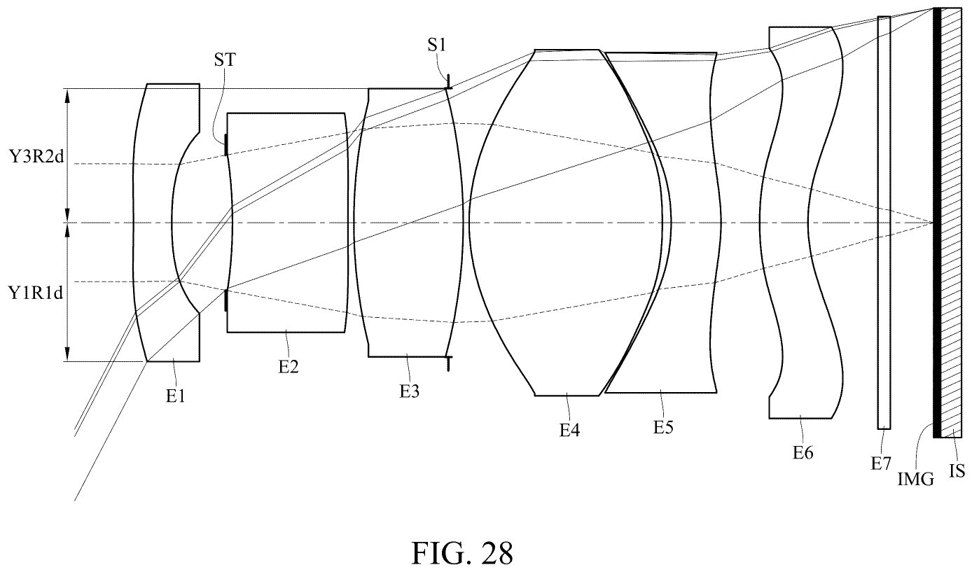

Using the wavelength of helium d-line as the reference wavelength for the optical system lens assembly, a maximum effective radius of the object-side surface of the first lens element is Y1R1d, a maximum effective radius of the image-side surface of the third lens element is Y3R2d, and the following condition can be satisfied: 0.70<Y1R1d/Y3R2d<1.30. Therefore, it is favorable for adjusting optical effective radii of the first lens element and the third lens element to balance the light travelling direction on the image side and reduce the angle of incidence on the image surface, thereby expanding the field of view and enhancing illuminance. Moreover, the following condition can also be satisfied: 0.80<Y1R1d/Y3R2d<1.20. Please refer to FIG. 28, which shows a schematic view of Y1R1d and Y3R2d according to the 1st embodiment of the present disclosure.

A maximum image height of the optical system lens assembly (which can be half of a diagonal length of an effective photosensitive area of an image sensor) is ImgH; using the wavelength of helium d-line as the reference wavelength for the optical system lens assembly, the maximum effective radius of the object-side surface of the first lens element is Y1R1d; and the following condition can be satisfied: 0.55<Y1R1d/ImgH<0.80. Therefore, it is favorable for balancing the object-side effective radius of the first lens element and the image height for adjustment of the light travelling direction, thereby reducing the outer diameter of the object-side end of the optical system lens assembly and enlarging the image surface. Moreover, the following condition can also be satisfied: 0.58<Y1R1d/ImgH<0.75.

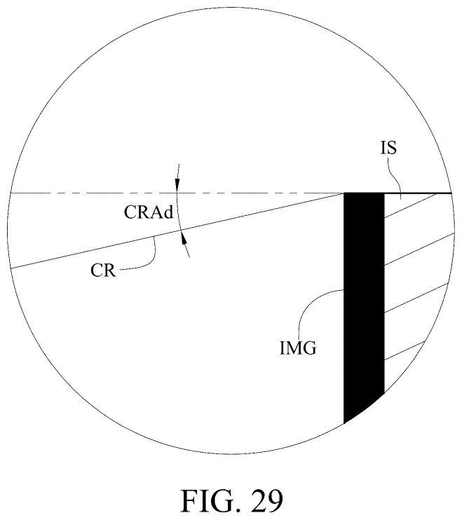

Using the wavelength of helium d-line as the reference wavelength for the optical system lens assembly, a chief ray angle of the maximum field of view on the image surface of the optical system lens assembly is CRAd, and the following condition can be satisfied: 5.0 degrees<CRAd<25.0 degrees. Therefore, it is favorable for increasing the illuminance of the peripheral field of view by reducing the angle of incidence on the image surface. Moreover, the following condition can also be satisfied: 8.0 degrees<CRAd<20.0 degrees. Please refer to 29, which shows a schematic view of a chief ray angle CRAd according to the present disclosure. In FIG. 29, a chief ray CR of the maximum field of view is incident on the image surface IMG at an image position, and the angle between a normal line of the image surface IMG and the chief ray CR of the maximum field of view is the chief ray angle CRAd of the maximum field of view on the image surface IMG.

When a curvature radius of the object-side surface of the first lens element is R1, and a curvature radius of the image-side surface of the sixth lens element is R12, the following condition can be satisfied: 0<(R1+R12)/(R1−R12)<2.50. Therefore, it is favorable for effectively balancing the curvature radii of the object-side surface of the first lens element and the image-side surface of the sixth lens element to enhance the light-gathering quality of imaging rays, effectively reducing field curvature and minimizing spherical aberration. Moreover, the following condition can also be satisfied: 0.10<(R1+R12)/(R1−R12)<2.00. Moreover, the following condition can also be satisfied: 0.50<(R1+R12)/(R1−R12)<1.60.

Using the wavelength of helium d-line as the reference wavelength for the optical system lens assembly, a focal length of the fourth lens element is f4d, the focal length of the sixth lens element is f6d, and the following condition can be satisfied: −2.00<f4d/f6d<−0.15. Therefore, it is favorable for adjusting the refractive power ratio between the fourth lens element and the sixth lens element to effectively control the light path direction, thereby reducing the angle of light incidence on the image surface. Moreover, the following condition can also be satisfied: −1.80<f4d/f6d<−0.20. Moreover, the following condition can also be satisfied: −1.50<f4d/f6d<−0.30.

When a central thickness of the fourth lens element is CT4, and a central thickness of the sixth lens element is CT6, the following condition can be satisfied: 2.50<CT4/CT6<6.50. Therefore, it is favorable for balancing the central thicknesses of the fourth lens element and the sixth lens element, and by having a greater central thickness of the fourth lens element, the angle of light incidence on the object-side surface of the sixth lens element is reduced to prevent total internal reflection and stray light generation, while balancing the spatial arrangement of the lens elements. Moreover, the following condition can also be satisfied: 2.80<CT4/CT6<5.00.

A curvature radius of the object-side surface of the sixth lens element is R11, and the curvature radius of the image-side surface of the sixth lens element is R12; using the wavelength of helium d-line as the reference wavelength for the optical system lens assembly, the focal length of the optical system lens assembly is fd; and the following condition can be satisfied: 1.00<fd/R11+fd/R12<4.00. Therefore, it is favorable for effectively balancing the curvature radius of the object-side surface and the image-side surface of the sixth lens element to adjust the travelling direction of peripheral light, thereby correcting astigmatism and reducing stray light within an optical lens. Moreover, the following condition can also be satisfied: 1.40<fd/R11+fd/R12<3.00. Moreover, the following condition can also be satisfied: 1.60<fd/R11+fd/R12<3.50.

According to the present disclosure, the optical system lens assembly can further include an aperture stop. When an axial distance between the aperture stop and the image-side surface of the sixth lens element is SD, and an axial distance between the object-side surface of the first lens element and the image-side surface of the sixth lens element is TD, the following condition can be satisfied: 0.75<SD/TD<1.10. Therefore, it is favorable for increasing the amount of incident light of the optical system lens assembly to enhance the illuminance of peripheral field of view. Moreover, the following condition can also be satisfied: 0.80<SD/TD<1.00.

Using the wavelength of helium d-line as the reference wavelength for the optical system lens assembly, the focal length of the optical system lens assembly is fd, the focal length of the fifth lens element is f5d, and the following condition can be satisfied: −0.45<fd/f5d<0.70. Therefore, it is favorable for balancing the refractive power at the image-side end, while improving field curvature, and reducing the generation of stray light. Moreover, the following condition can also be satisfied: −0.35<fd/f5d<0.60. Moreover, the following condition can also be satisfied: −0.20<fd/f5d<0.50.

The maximum image height of the optical system lens assembly is ImgH; using the wavelength of helium d-line as the reference wavelength for the optical system lens assembly, the axial distance between the object-side surface of the first lens element and the image surface is TLd; and the following condition can be satisfied: 2.80<TLd/ImgH<5.00. Therefore, it is favorable for achieving a balance between maintaining the total track length of the optical system lens assembly and enlarging the image surface. Moreover, the following condition can also be satisfied: 3.20<TLd/ImgH<4.50.

When a central thickness of the first lens element is CT1, and the central thickness of the second lens element is CT2, the following condition can be satisfied: 0.05<CT1/CT2<1.00. Therefore, it is favorable for adjusting the spatial ratio of the central thicknesses between the first lens element and the second lens element to provide sufficient space for large-angle light to converge, thereby improving peripheral light-gathering quality. Moreover, the following condition can also be satisfied: 0.10<CT1/CT2<0.80. Moreover, the following condition can also be satisfied: 0.20<CT1/CT2<0.60.

When a curvature radius of the object-side surface of the fourth lens element is R7, and a curvature radius of the image-side surface of the fourth lens element is R8, the following condition can be satisfied: −0.60<(R7+R8)/(R7−R8)<0.35. Therefore, it is favorable for adjusting the curvature radii of the object-side surface and the image-side surface of the fourth lens element to have more curved surface shape, thereby facilitating light convergence and enlarging the image surface. Moreover, the following condition can also be satisfied: −0.45<(R7+R8)/(R7−R8)<0.30.

Using the wavelength of helium d-line as the reference wavelength for the optical system lens assembly, the Abbe number of the first lens element is V1d, an Abbe number of the second lens element is V2d, and the following condition can be satisfied: 0.60<V2d/V1d<4.00. Therefore, it is favorable for adjusting the material configuration of the first lens element and the second lens element to balance the converging ability across different light wavelengths. Moreover, the following condition can also be satisfied: 1.00<V2d/V1d<3.70. Moreover, the following condition can also be satisfied: 1.50<V2d/V1d<3.20.

According to the present disclosure, if the parameters of the optical system lens assembly, the image capturing unit and the electronic device are not specifically defined for a reference wavelength, the parameters may be determined based on the reference wavelength of the system.

According to the present disclosure, the aforementioned features and conditions can be utilized in numerous combinations so as to achieve corresponding effects.

According to the present disclosure, the lens elements of the optical system lens assembly can be made of either glass or plastic material. When the lens elements are made of glass material, the refractive power distribution of the optical system lens assembly may be more flexible, and the influence on imaging caused by external environment temperature change may be reduced. The glass lens element can either be made by grinding or molding. When the lens elements are made of plastic material, the manufacturing costs can be effectively reduced. Furthermore, surfaces of each lens element can be arranged to be spherical or aspheric. Spherical lens elements are simple in manufacture. Aspheric lens element design allows more control variables for eliminating aberrations thereof and reducing the required number of lens elements, and the total track length of the optical system lens assembly can therefore be effectively shortened. Additionally, the aspheric surfaces may be formed by plastic injection molding or glass molding.

According to the present disclosure, when a lens surface is aspheric, it means that the lens surface has an aspheric shape throughout its optically effective area, or a portion(s) thereof.

According to the present disclosure, one or more of the lens elements' material may optionally include an additive which generates light absorption and interference effects and alters the lens elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material lens element by injection molding. Moreover, the additive may be coated on the lens surfaces to provide the abovementioned effects.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, unless otherwise stated, when the lens element has a convex surface, it indicates that the surface is convex in the paraxial region thereof; when the lens element has a concave surface, it indicates that the surface is concave in the paraxial region thereof. Moreover, when a region of curvature radius, refractive power or focus of a lens element is not defined, it indicates that the region of curvature radius, refractive power or focus of the lens element is in the paraxial region thereof.

According to the present disclosure, an inflection point is a point on the surface of the lens element at which the surface changes from concave to convex, or vice versa. A critical point is a non-axial point of the lens surface where its tangent is perpendicular to the optical axis.

According to the present disclosure, the image surface of the optical system lens assembly, based on the corresponding image sensor, can be flat or curved, especially a curved surface being concave facing towards the object side of the optical system lens assembly.

According to the present disclosure, an image correction unit, such as a field flattener, can be optionally disposed between the lens element closest to the image side of the optical system lens assembly along the optical path and the image surface for correction of aberrations such as field curvature. The optical properties of the image correction unit, such as curvature, thickness, index of refraction, position and surface shape (convex or concave surface with spherical, aspheric, diffractive or Fresnel types), can be adjusted according to the design of the image capturing unit. In general, a preferable image correction unit is, for example, a thin transparent element having a concave object-side surface and a planar image-side surface, and the thin transparent element is disposed near the image surface.

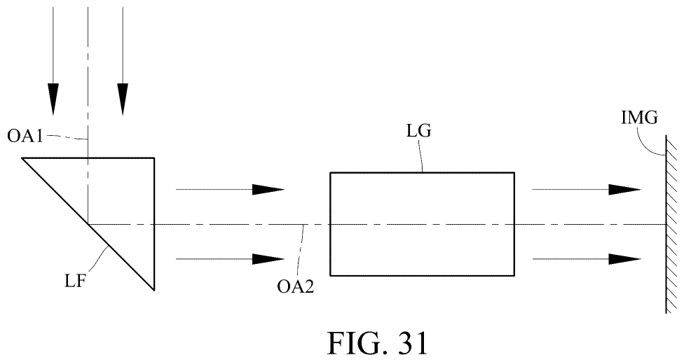

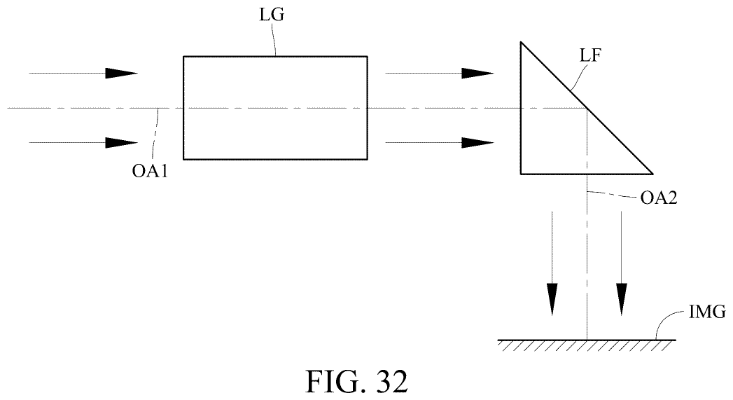

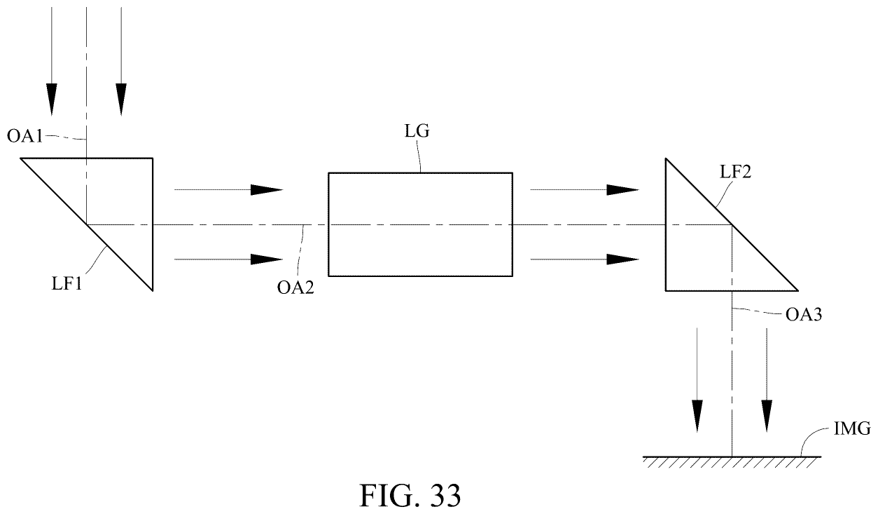

According to the present disclosure, at least one light-folding element, such as a prism or a mirror, can be optionally provided between an imaged object and the image surface on the imaging optical path, and the surface shape of the prism or mirror can be planar, spherical, aspheric or freeform surface, such that the optical system lens assembly can be more flexible in space arrangement, and therefore the dimensions of an electronic device is not restricted by the total track length of the optical system lens assembly. Specifically, please refer to FIG. 31 and FIG. 32. FIG. 31 shows a schematic view of a configuration of one light-folding element in an optical system lens assembly according to one embodiment of the present disclosure, and FIG. 32 shows a schematic view of another configuration of one light-folding element in an optical system lens assembly according to one embodiment of the present disclosure. In FIG. 31 and FIG. 32, the optical system lens assembly can have, in order from an imaged object (not shown in the figures) to an image surface IMG along an optical path, a first optical axis OA1, a light-folding element LF and a second optical axis OA2. The light-folding element LF can be disposed between the imaged object and a lens group LG of the optical system lens assembly as shown in FIG. 31, or disposed between a lens group LG and the image surface IMG of the optical system lens assembly as shown in FIG. 32. Furthermore, please refer to FIG. 33, which shows a schematic view of a configuration of two light-folding elements in an optical system lens assembly according to one embodiment of the present disclosure. In FIG. 33, the optical system lens assembly can have, in order from an imaged object (not shown in the figure) to an image surface IMG along an optical path, a first optical axis OA1, a first light-folding element LF1, a second optical axis OA2, a second light-folding element LF2 and a third optical axis OA3. The first light-folding element LF1 is disposed between the imaged object and a lens group LG of the optical system lens assembly, the second light-folding element LF2 is disposed between the lens group LG and the image surface IMG of the optical system lens assembly, and the travelling direction of light on the first optical axis OA1 can be the same direction as the travelling direction of light on the third optical axis OA3 as shown in FIG. 33. The optical system lens assembly can be optionally provided with three or more light-folding elements, and the present disclosure is not limited to the type, amount and position of the light-folding elements of the embodiments disclosed in the aforementioned figures.

According to the present disclosure, the optical system lens assembly can include at least one stop, such as an aperture stop, a glare stop or a field stop. Said glare stop or said field stop is set for eliminating the stray light and thereby improving image quality thereof.

According to the present disclosure, an aperture stop can be configured as a front stop or a middle stop. A front stop disposed between an imaged object and the first lens element can provide a longer distance between an exit pupil of the optical system lens assembly and the image surface to produce a telecentric effect, and thereby improves the image-sensing efficiency of an image sensor (for example, CCD or CMOS). A middle stop disposed between the first lens element and the image surface is favorable for enlarging the viewing angle of the optical system lens assembly and thereby provides a wider field of view for the same.

According to the present disclosure, the optical system lens assembly can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material or a liquid-crystal layer. The aperture control unit controls the amount of incident light or exposure time to enhance the capability of image quality adjustment. In addition, the aperture control unit can be the aperture stop of the present disclosure, which changes the f-number to obtain different image effects, such as the depth of field or lens speed.

According to the present disclosure, the optical system lens assembly can include one or more optical elements for limiting the form of light passing through the optical system lens assembly. Each optical element can be, but not limited to, a filter, a polarizer, etc., and each optical element can be, but not limited to, a single-piece element, a composite component, a thin film, etc. The optical element can be located at the object side or the image side of the optical system lens assembly or between any two adjacent lens elements so as to allow light in a specific form to pass through, thereby meeting application requirements.

According to the present disclosure, the optical system lens assembly can include at least one optical lens element, an optical element, or a carrier, which has at least one surface with a low reflection layer. The low reflection layer can effectively reduce stray light generated due to light reflection at the interface. The low reflection layer can be disposed in an optical non-effective area of an object-side surface or an image-side surface of the said optical lens element, or a connection surface between the object-side surface and the image-side surface. The said optical element can be a light-blocking element, an annular spacer, a barrel element, a cover glass, a blue glass, a filter, a color filter, an optical path folding element (e.g., a reflective element), a prism, a mirror, etc. The said carrier can be a base for supporting a lens assembly, a micro lens disposed on an image sensor, a substrate surrounding the image sensor, a glass plate for protecting the image sensor, etc. According to the present disclosure, the object side and image side are defined in accordance with the direction of the optical axis, and the axial optical data are calculated along the optical axis. Furthermore, if the optical axis is deflected by a light-folding element, the axial optical data are also calculated along the deflected optical axis.

According to the above description of the present disclosure, the following specific embodiments are provided for further explanation.

### 1st Embodiment

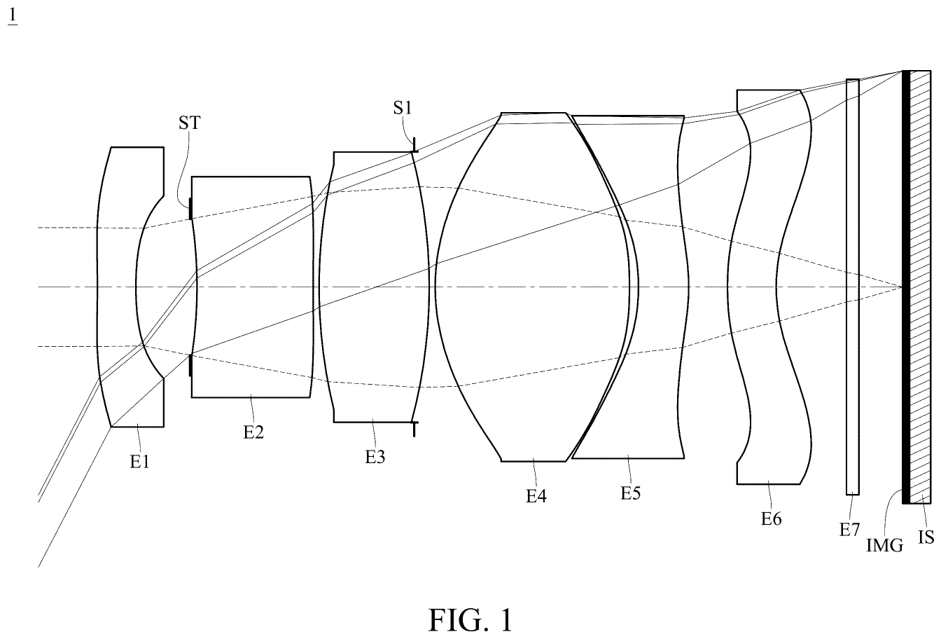

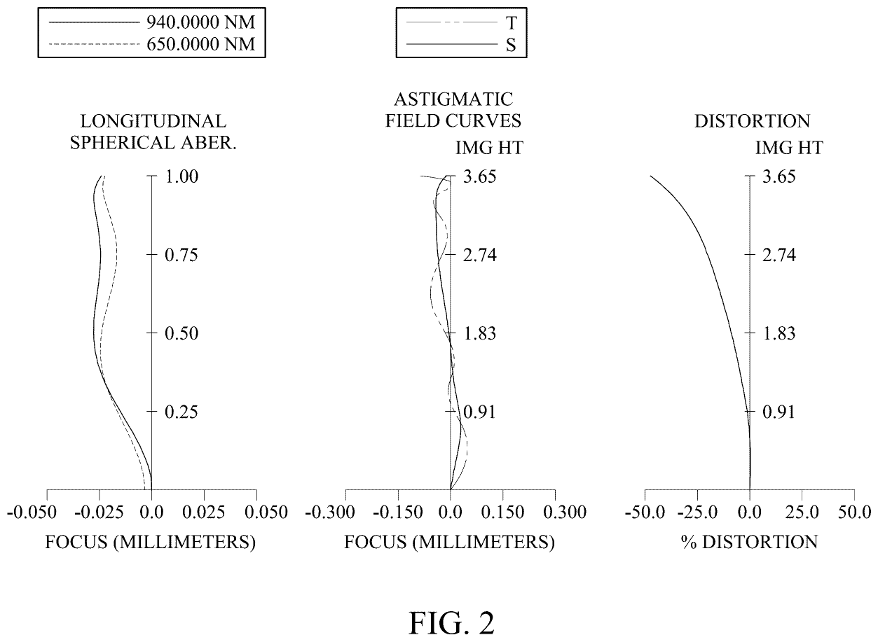

FIG. 1 is a schematic view of an image capturing unit according to the 1st embodiment of the present disclosure. FIG. 2 shows, in order from left to right, spherical aberration curves, astigmatic field curves and a distortion curve of the image capturing unit according to the 1st embodiment. In FIG. 1, the image capturing unit 1 includes the optical system lens assembly (its reference numeral is omitted) of the present disclosure and an image sensor IS. The optical system lens assembly includes, in order from an object side to an image side along an optical path, a first lens element E1, an aperture stop ST, a second lens element E2, a third lens element E3, a stop S1, a fourth lens element E4, a fifth lens element E5, a sixth lens element E6, a filter E7 and an image surface IMG. The optical system lens assembly includes six lens elements (E1, E2, E3, E4, E5 and E6) with no additional lens element disposed between each of the adjacent six lens elements.

The first lens element E1 with negative refractive power has an object-side surface being concave in a paraxial region thereof and an image-side surface being concave in a paraxial region thereof. The first lens element E1 is made of plastic material and has the object-side surface and the image-side surface being both aspheric. The object-side surface of the first lens element E1 has two inflection points. The object-side surface of the first lens element E1 has one critical point in an off-axis region thereof.

The second lens element E2 with negative refractive power has an object-side surface being concave in a paraxial region thereof and an image-side surface being concave in a paraxial region thereof. The second lens element E2 is made of plastic material and has the object-side surface and the image-side surface being both aspheric. The image-side surface of the second lens element E2 has one inflection point. The image-side surface of the second lens element E2 has one critical point in an off-axis region thereof.

The third lens element E3 with positive refractive power has an object-side surface being convex in a paraxial region thereof and an image-side surface being convex in a paraxial region thereof. The third lens element E3 is made of glass material and has the object-side surface and the image-side surface being both spherical.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point.

The fifth lens element E5 with positive refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has two inflection points. The image-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the optical system lens assembly. The image sensor IS is disposed on or near the image surface IMG of the optical system lens assembly.

The equation of the aspheric surface profiles of the aforementioned lens elements of the 1st embodiment is expressed as follows:

$$X ( Y ) = ( {Y}^{2} / R ) / ( 1 + s q r t ( 1 - ( 1 + k ) \times {( Y / R )}^{2} ) ) + {\sum }_{i} ( Ai ) \times ( {Y}^{i} ) ,$$

where,
X is the displacement in parallel with an optical axis from an axial vertex on the aspheric surface to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient, and in the embodiments, i may be, but is not limited to, 4, 6, 8, 10, 12, 14 and 16.

In this embodiment, using a wavelength of 940.0 nm as a reference wavelength for the optical system lens assembly of the image capturing unit 1 according to the 1st embodiment, a focal length of the optical system lens assembly is f, an f-number of the optical system lens assembly is Fno, half of a maximum field of view of the optical system lens assembly is HFOV, and these parameters have the following values: f=3.61 millimeters (mm), Fno=1.80, and HFOV=62.6 degrees (deg.). Using a wavelength of helium d-line as a reference wavelength for the optical system lens assembly of the image capturing unit 1 according to the 1st embodiment, a focal length of the optical system lens assembly is fd, half of a maximum field of view of the optical system lens assembly is HFOVd, a total track length of the optical system lens assembly is TLd, and these parameters have the following values: fd=3.55 mm, HFOVd=62.6 degrees, and TLd=13.600 mm.

Some of the following parameters are measured at the wavelength of helium d-line, and there would be descriptions of “at the wavelength of helium d-line” noted in the definitions of these parameters. However, if the parameters are not specifically defined for a reference wavelength, these parameters may be determined according to a default of the reference wavelength for the optical system lens assembly, such as 940.0 nm in this embodiment.

When an axial distance between the object-side surface of the first lens element E1 and the image surface IMG at the wavelength of helium d-line is TLd, and the focal length of the optical system lens assembly at the wavelength of helium d-line is fd, the following condition is satisfied: TLd/fd=3.83.

When the axial distance between the object-side surface of the first lens element E1 and the image surface IMG at the wavelength of helium d-line is TLd, and a maximum image height of the optical system lens assembly is ImgH, the following condition is satisfied: TLd/ImgH=3.73.

When an axial distance between the aperture stop ST and the image-side surface of the sixth lens element E6 is SD, and an axial distance between the object-side surface of the first lens element E1 and the image-side surface of the sixth lens element E6 is TD, the following condition is satisfied: SD/TD=0.86.

When the focal length of the optical system lens assembly at the wavelength of helium d-line is fd, and a focal length of the fifth lens element E5 at the wavelength of helium d-line is f5d, the following condition is satisfied: fd/f5d=0.06.

When a focal length of the fourth lens element E4 at the wavelength of helium d-line is f4d, and a focal length of the sixth lens element E6 at the wavelength of helium d-line is f6d, the following condition is satisfied: f4d/f6d=−0.45.

When the focal length of the fifth lens element E5 at the wavelength of helium d-line is f5d, and the focal length of the sixth lens element E6 at the wavelength of helium d-line is f6d, the following condition is satisfied: |f6d/f5d|=0.19.

When the focal length of the optical system lens assembly at the wavelength of helium d-line is fd, a curvature radius of the object-side surface of the sixth lens element E6 is R11, and a curvature radius of the image-side surface of the sixth lens element E6 is R12, the following condition is satisfied: fd/R11+fd/R12=1.95.

When a curvature radius of the object-side surface of the first lens element E1 is R1, and the curvature radius of the image-side surface of the sixth lens element E6 is R12, the following condition is satisfied: (R1+R12)/(R1−R12)=0.74.

When a curvature radius of the object-side surface of the third lens element E3 is R5, and a curvature radius of the image-side surface of the third lens element E3 is R6, the following condition is satisfied: (R5+R6)/(R5−R6)=0.00.

When a curvature radius of the object-side surface of the fourth lens element E4 is R7, and a curvature radius of the image-side surface of the fourth lens element E4 is R8, the following condition is satisfied: (R7+R8)/(R7−R8)=−0.36.

When a central thickness of the first lens element E1 is CT1, and a central thickness of the second lens element E2 is CT2, the following condition is satisfied: CT1/CT2=0.33.

When the central thickness of the second lens element E2 is CT2, and an axial distance between the first lens element E1 and the second lens element E2 is T12, the following condition is satisfied: CT2/T12=1.90. In this embodiment, an axial distance between two adjacent lens elements is a distance in a paraxial region between two adjacent lens surfaces of the two adjacent lens elements.

When a central thickness of the fourth lens element E4 is CT4, and a central thickness of the sixth lens element E6 is CT6, the following condition is satisfied: CT4/CT6=3.99.

When a central thickness of the third lens element E3 is CT3, and a central thickness of the fifth lens element E5 is CT5, the following condition is satisfied: CT5/CT3=0.46.

When a sum of axial distances between each of all adjacent lens elements of the optical system lens assembly is ΣAT, and a sum of central thicknesses of all lens elements of the optical system lens assembly is ΣCT, the following condition is satisfied: ΣAT/ΣCT=0.22. In this embodiment, ΣAT is equal to a sum of the axial distance between the first lens element E1 and the second lens element E2, an axial distance between the second lens element E2 and the third lens element E3, an axial distance between the third lens element E3 and the fourth lens element E4, an axial distance between the fourth lens element E4 and the fifth lens element E5, and an axial distance between the fifth lens element E5 and the sixth lens element E6. In addition, in this embodiment, ΣCT is equal to a sum of the central thickness of the first lens element E1, the central thickness of the second lens element E2, the central thickness of the third lens element E3, the central thickness of the fourth lens element E4, the central thickness of the fifth lens element E5, and the central thickness of the sixth lens element E6.

When a maximum among axial distances between each of all adjacent lens elements of the optical system lens assembly is MaxAT, and the central thickness of the fifth lens element E5 is CT5, the following condition is satisfied: MaxAT/CT5=1.22. In this embodiment, the axial distance between the first lens element E1 and the second lens element E2 is larger than the axial distance between the second lens element E2 and the third lens element E3, the axial distance between the third lens element E3 and the fourth lens element E4, the axial distance between the fourth lens element E4 and the fifth lens element E5 and the axial distance between the fifth lens element E5 and the sixth lens element E6, and MaxAT is equal to the axial distance between the first lens element E1 and the second lens element E2.

When an Abbe number of the first lens element E1 at the wavelength of helium d-line is V1d, the following condition is satisfied: V1d=25.7.

When the Abbe number of the first lens element E1 at the wavelength of helium d-line is V1d, and an Abbe number of the second lens element E2 at the wavelength of helium d-line is V2d, the following condition is satisfied: V2d/V1d=0.76.

When an Abbe number of the fifth lens element E5 at the wavelength of helium d-line is V5d, and an Abbe number of the sixth lens element E6 at the wavelength of helium d-line is V6d, the following condition is satisfied: V5d+V6d=39.0.

When a maximum effective radius of the object-side surface of the first lens element E1 at the wavelength of helium d-line is Y1R1d, and a maximum effective radius of the image-side surface of the third lens element E3 at the wavelength of helium d-line is Y3R2d, the following condition is satisfied: Y1R1d/Y3R2d=1.04.

When the maximum effective radius of the object-side surface of the first lens element E1 at the wavelength of helium d-line is Y1R1d, and the maximum image height of the optical system lens assembly is ImgH, the following condition is satisfied: Y1R1d/ImgH=0.65.

When a chief ray angle of the maximum field of view on the image surface IMG of the optical system lens assembly at the wavelength of helium d-line is CRAd, the following condition is satisfied: CRAd=12.7 degrees.

The detailed optical data of the 1st embodiment are shown in Table 1A and the aspheric surface data are shown in Table 1B below.

TABLE 1A
1st Embodiment
f = 3.61 mm, Fno = 1.80, HFOV = 62.6 deg.

| | | | | | | Index | | | Focal Length | |
|---|---|---|---|---|---|---|---|---|---|---|
| Surface # | | Curvature Radius | | Thickness | Material | 940.0 nm | d-line | Abbe # | 940.0 nm | d-line |
| 0 | Object | Plano | | Infinity | | | | | | |
| 1 | Lens 1 | −18.7404 | (ASP) | 0.650 | Plastic | 1.594 | 1.614 | 25.7 | −6.80 | −6.57 |
| 2 | | 5.2106 | (ASP) | 0.913 | | | | | | |
| 3 | Ape. Stop | Plano | | 0.118 | | | | | | |
| 4 | Lens 2 | −8.0776 | (ASP) | 1.963 | Plastic | 1.644 | 1.671 | 19.5 | −10.67 | −10.23 |
| 5 | | 50.1632 | (ASP) | 0.100 | | | | | | |
| 6 | Lens 3 | 8.7707 | (SPH) | 1.860 | Glass | 1.716 | 1.729 | 54.7 | 6.41 | 6.30 |
| 7 | | −8.7707 | (SPH) | −0.254 | | | | | | |
| 8 | Stop | Plano | | 0.354 | | | | | | |
| 9 | Lens 4 | 3.4603 | (ASP) | 3.281 | Plastic | 1.536 | 1.545 | 56.0 | 4.92 | 4.84 |
| 10 | | −7.4023 | (ASP) | 0.151 | | | | | | |
| 11 | Lens 5 | −3.2867 | (ASP) | 0.848 | Plastic | 1.644 | 1.671 | 19.5 | 60.82 | 56.59 |
| 12 | | −3.3384 | (ASP) | 0.656 | | | | | | |
| 13 | Lens 6 | 5.1401 | (ASP) | 0.822 | Plastic | 1.644 | 1.671 | 19.5 | −11.26 | −10.84 |
| 14 | | 2.8188 | (ASP) | 1.187 | | | | | | |

| | | | | | | | | | |
|---|---|---|---|---|---|---|---|---|---|
| 15 | Filter | Plano | 0.210 | Glass | 1.508 | 1.516 | 64.1 | — | — |
| 16 | | Plano | 0.739 | | | | | | |
| 17 | Image | Plano | — | | | | | | |

Note:
Reference wavelength is 940.0 nm.
An effective radius of the stop S1 (Surface 8) is 2.285 mm.
When reference wavelength is 587.6 nm (d-line), fd = 3.55 mm, HFOVd = 62.6 degrees, and TLd = 13.600 mm.

TABLE 1B
Aspheric Coefficients

| Surface # | 1 | 2 | 4 | 5 | 9 |
|---|---|---|---|---|---|
| k= | 4.72744E+01 | 1.58525E+00 | −9.90000E+01 | 9.90000E+01 | 7.54351E−02 |
| A4= | 2.89567E−02 | 3.87030E−02 | −2.24854E−02 | −9.72473E−03 | −6.16932E−03 |
| A6= | −5.42499E−03 | −8.29912E−04 | 8.45713E−03 | 1.26015E−03 | 4.45717E−04 |
| A8= | 9.36531E−04 | 1.78873E−03 | −1.89691E−03 | −3.24310E−04 | −4.24174E−05 |
| A10= | −1.16131E−04 | −1.05003E−03 | 5.23904E−05 | 3.40127E−05 | −1.09532E−05 |
| A12= | 6.41612E−06 | 2.46693E−04 | — | — | 2.13563E−06 |
| A14= | — | — | — | — | −1.42533E−07 |

| Surface # | 10 | 11 | 12 | 13 | 14 |
|---|---|---|---|---|---|
| k= | 2.02441E+00 | 7.17038E−02 | −9.45820E+00 | 8.93016E−01 | −5.53919E+00 |
| A4= | −6.20546E−02 | −2.06202E−02 | 4.02375E−02 | 3.03997E−02 | 1.88471E−02 |
| A6= | 2.32286E−02 | 1.18175E−02 | −1.48709E−02 | −1.80969E−02 | −1.08254E−02 |
| A8= | −3.94752E−03 | −1.98153E−03 | 3.25350E−03 | 4.00193E−03 | 2.43134E−03 |
| A10= | 3.21886E−04 | 1.50856E−04 | −3.98391E−04 | −5.52789E−04 | −3.20753E−04 |
| A12= | −1.02146E−05 | −3.71468E−06 | 2.64137E−05 | 4.79908E−05 | 2.50792E−05 |
| A14= | 3.21260E−10 | — | −7.56307E−07 | −2.50852E−06 | −1.09869E−06 |
| A16= | — | — | — | 6.15051E−08 | 2.10866E−08 |

In Table 1A, the curvature radius, the thickness and the focal length are shown in millimeters (mm). Surface numbers 0-17 represent the surfaces sequentially arranged from the object side to the image side along the optical axis. In Table 1B, k represents the conic coefficient of the equation of the aspheric surface profiles. A4-A16 represent the aspheric coefficients ranging from the 4th order to the 16th order. The tables presented below for each embodiment are the corresponding schematic parameter and aberration curves, and the definitions of the tables are the same as Table 1A and Table 1B of the 1st embodiment. Therefore, an explanation in this regard will not be provided again.

### 2nd Embodiment

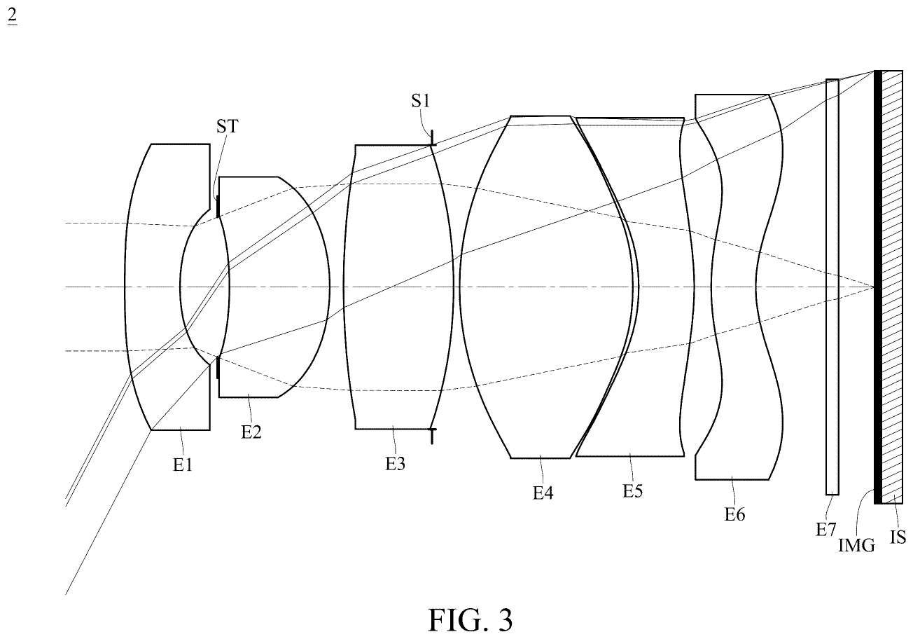

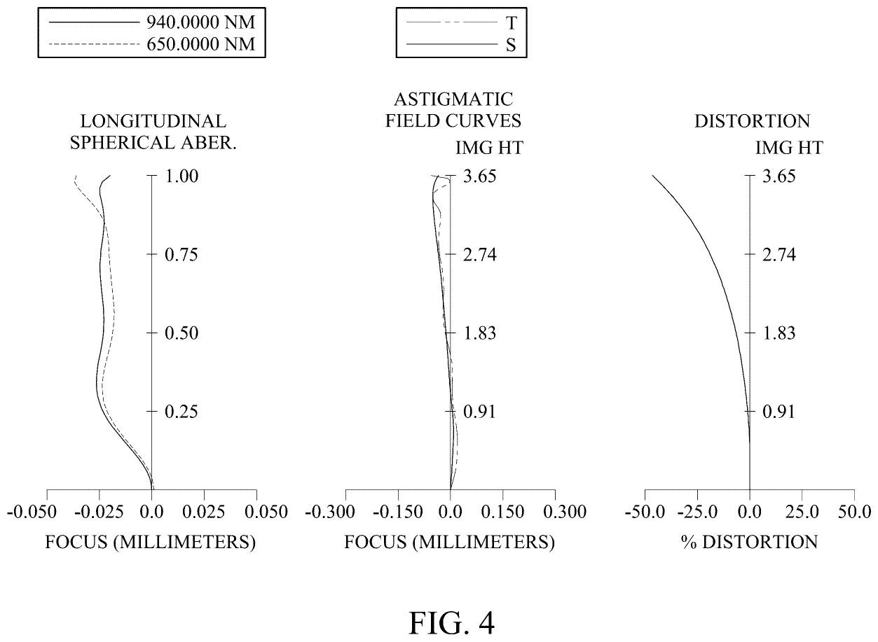

FIG. 3 is a schematic view of an image capturing unit according to the 2nd embodiment of the present disclosure. FIG. 4 shows, in order from left to right, spherical aberration curves, astigmatic field curves and a distortion curve of the image capturing unit according to the 2nd embodiment. In FIG. 3, the image capturing unit 2 includes the optical system lens assembly (its reference numeral is omitted) of the present disclosure and an image sensor IS. The optical system lens assembly includes, in order from an object side to an image side along an optical path, a first lens element E1, an aperture stop ST, a second lens element E2, a third lens element E3, a stop S1, a fourth lens element E4, a fifth lens element E5, a sixth lens element E6, a filter E7 and an image surface IMG. The optical system lens assembly includes six lens elements (E1, E2, E3, E4, E5 and E6) with no additional lens element disposed between each of the adjacent six lens elements.

The first lens element E1 with negative refractive power has an object-side surface being convex in a paraxial region thereof and an image-side surface being concave in a paraxial region thereof. The first lens element E1 is made of plastic material and has the object-side surface and the image-side surface being both aspheric.

The second lens element E2 with positive refractive power has an object-side surface being concave in a paraxial region thereof and an image-side surface being convex in a paraxial region thereof. The second lens element E2 is made of plastic material and has the object-side surface and the image-side surface being both aspheric.

The third lens element E3 with positive refractive power has an object-side surface being convex in a paraxial region thereof and an image-side surface being convex in a paraxial region thereof. The third lens element E3 is made of glass material and has the object-side surface and the image-side surface being both spherical.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The image-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the optical system lens assembly. The image sensor IS is disposed on or near the image surface IMG of the optical system lens assembly.

The detailed optical data of the 2nd embodiment are shown in Table 2A and the aspheric surface data are shown in Table 2B below.

TABLE 2A
2nd Embodiment
f = 3.55 mm, Fno = 1.65, HFOV = 62.5 deg.

| | | | | | | Index | | Abbe | Focal Length | |
|---|---|---|---|---|---|---|---|---|---|---|
| Surface # | | Curvature Radius | | Thickness | Material | 940.0 nm | d-line | # | 940.0 nm | d-line |
| 0 | Object | Plano | | Infinity | | | | | | |
| 1 | Lens 1 | 24.2853 | (ASP) | 0.933 | Plastic | 1.644 | 1.671 | 19.5 | −5.19 | −4.98 |
| 2 | | 2.8921 | (ASP) | 0.632 | | | | | | |
| 3 | Ape. Stop | Plano | | 0.203 | | | | | | |
| 4 | Lens 2 | −5.0019 | (ASP) | 1.694 | Plastic | 1.536 | 1.545 | 56.0 | 12.39 | 12.15 |
| 5 | | −3.1896 | (ASP) | 0.233 | | | | | | |
| 6 | Lens 3 | 12.7346 | (SPH) | 1.860 | Glass | 1.521 | 1.530 | 60.5 | 9.30 | 9.15 |
| 7 | | −7.4385 | (SPH) | −0.364 | | | | | | |
| 8 | Stop | Plano | | 0.464 | | | | | | |
| 9 | Lens 4 | 4.8242 | (ASP) | 2.924 | Plastic | 1.536 | 1.545 | 56.0 | 4.75 | 4.68 |
| 10 | | −4.2448 | (ASP) | 0.100 | | | | | | |
| 11 | Lens 5 | −3.0797 | (ASP) | 0.938 | Plastic | 1.644 | 1.671 | 19.5 | −19.20 | −18.56 |
| 12 | | −4.5912 | (ASP) | 0.287 | | | | | | |
| 13 | Lens 6 | 4.3308 | (ASP) | 0.753 | Plastic | 1.644 | 1.671 | 19.5 | −10.68 | −10.29 |
| 14 | | 2.4757 | (ASP) | 1.188 | | | | | | |

| | | | | | | | | | |
|---|---|---|---|---|---|---|---|---|---|
| 15 | Filter | Plano | 0.210 | Glass | 1.508 | 1.516 | 64.1 | — | — |
| 16 | | Plano | 0.607 | | | | | | |
| 17 | Image | Plano | — | | | | | | |

Note:
Reference wavelength is 940.0 nm.
An effective radius of the stop S1 (Surface 8) is 2.398 mm.
When reference wavelength is 587.6 nm (d-line), fd = 3.51 mm, HFOVd = 63.1 degrees, and TLd = 12.669 mm.

TABLE 2B
Aspheric Coefficients

| Surface # | 1 | 2 | 4 | 5 | 9 |
|---|---|---|---|---|---|
| k= | 2.74923E+01 | 2.70173E+00 | −7.48949E+01 | 1.47561E+00 | 1.38217E+00 |
| A4= | 1.85466E−02 | 3.05564E−02 | −7.15159E−02 | −5.56937E−03 | −2.68959E−03 |
| A6= | −3.37534E−03 | 1.84994E−03 | 4.90618E−02 | −1.05676E−04 | 1.08285E−05 |
| A8= | 5.66000E−04 | −3.93822E−03 | −2.82503E−02 | −6.28315E−05 | 4.32257E−06 |
| A10= | −6.26159E−05 | 2.49952E−03 | 6.11821E−03 | −3.27378E−05 | −1.05932E−05 |
| A12= | 3.13848E−06 | — | — | — | 1.75737E−06 |
| A14= | — | — | — | — | −1.36022E−07 |

| Surface # | 10 | 11 | 12 | 13 | 14 |
|---|---|---|---|---|---|
| k= | 1.55141E−01 | −2.48339E−02 | −2.10962E+01 | 1.10018E+00 | −4.16533E+00 |
| A4= | −4.02803E−02 | −1.96032E−02 | 1.80931E−02 | 4.15391E−03 | 8.36631E−03 |
| A6= | 1.95231E−02 | 1.38970E−02 | −1.19317E−02 | −1.70696E−02 | −1.23826E−02 |
| A8= | −3.65615E−03 | −2.55654E−03 | 3.79863E−03 | 3.18318E−03 | 3.46966E−03 |
| A10= | 3.13691E−04 | 2.05986E−04 | −6.14046E−04 | −4.96336E−06 | −5.19061E−04 |
| A12= | −1.00560E−05 | −5.19135E−06 | 5.09679E−05 | −7.60112E−05 | 4.41290E−05 |
| A14= | — | — | −1.70098E−06 | 9.89265E−06 | −2.01021E−06 |
| A16= | — | — | — | −4.09934E−07 | 3.82672E−08 |

In the 2nd embodiment, the equation of the aspheric surface profiles of the aforementioned lens elements is the same as the equation of the 1st embodiment. Also, the definitions of these parameters shown in Table 2C below are the same as those stated in the 1st embodiment with corresponding values for the 2nd embodiment, so an explanation in this regard will not be provided again.

Moreover, these parameters can be calculated from Table 2A and Table 2B as the following values and satisfy the following conditions:

TABLE 2C
Values of Optical and Physical Parameters/Definitions

| | | | |
|---|---|---|---|
| fd [mm] | 3.51 | CT1/CT2 | 0.55 |
| Fno | 1.65 | CT2/T12 | 2.03 |
| HFOVd [deg.] | 63.1 | CT4/CT6 | 3.88 |
| TLd/fd | 3.61 | CT5/CT3 | 0.50 |
| TLd/ImgH | 3.47 | ΣAT/ΣCT | 0.17 |
| SD/TD | 0.85 | MaxAT/CT5 | 0.89 |
| fd/f5d | −0.19 | V1d | 19.5 |
| f4d/f6d | −0.45 | V2d/V1d | 2.87 |
| \|f6d/f5d\| | 0.55 | V5d + V6d | 39.0 |
| fd/R11 + fd/R12 | 2.23 | Y1R1d/Y3R2d | 1.01 |
| (R1 + R12)/(R1 − R12) | 1.23 | Y1R1d/ImgH | 0.66 |
| (R5 + R6)/(R5 − R6) | 0.26 | CRAd [deg.] | 14.8 |
| (R7 + R8)/(R7 − R8) | 0.06 | — | — |

### 3rd Embodiment

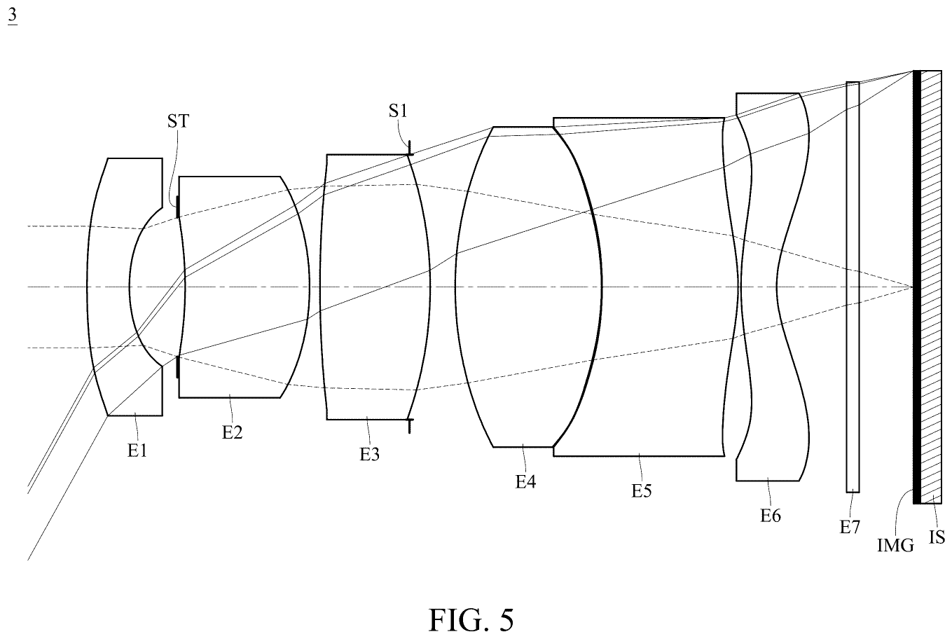

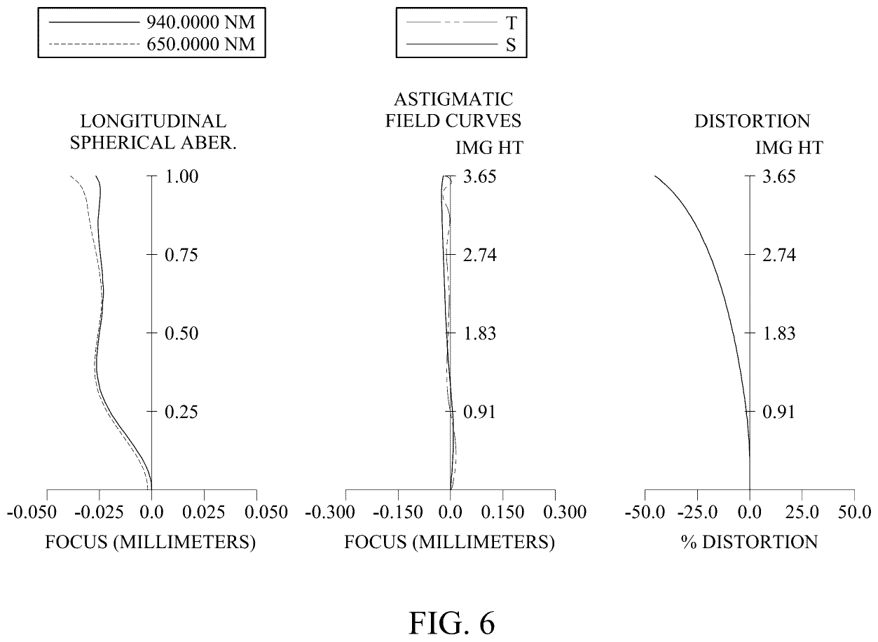

FIG. 5 is a schematic view of an image capturing unit according to the 3rd embodiment of the present disclosure. FIG. 6 shows, in order from left to right, spherical aberration curves, astigmatic field curves and a distortion curve of the image capturing unit according to the 3rd embodiment. In FIG. 5, the image capturing unit 3 includes the optical system lens assembly (its reference numeral is omitted) of the present disclosure and an image sensor IS. The optical system lens assembly includes, in order from an object side to an image side along an optical path, a first lens element E1, an aperture stop ST, a second lens element E2, a third lens element E3, a stop S1, a fourth lens element E4, a fifth lens element E5, a sixth lens element E6, a filter E7 and an image surface IMG. The optical system lens assembly includes six lens elements (E1, E2, E3, E4, E5 and E6) with no additional lens element disposed between each of the adjacent six lens elements.

The first lens element E1 with negative refractive power has an object-side surface being convex in a paraxial region thereof and an image-side surface being concave in a paraxial region thereof. The first lens element E1 is made of plastic material and has the object-side surface and the image-side surface being both aspheric. The object-side surface of the first lens element E1 has one inflection point.

The second lens element E2 with positive refractive power has an object-side surface being concave in a paraxial region thereof and an image-side surface being convex in a paraxial region thereof. The second lens element E2 is made of plastic material and has the object-side surface and the image-side surface being both aspheric. The object-side surface of the second lens element E2 has one inflection point.

The third lens element E3 with positive refractive power has an object-side surface being convex in a paraxial region thereof and an image-side surface being convex in a paraxial region thereof. The third lens element E3 is made of glass material and has the object-side surface and the image-side surface being both aspheric. The object-side surface of the third lens element E3 has one inflection point.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The image-side surface of the fourth lens element E4 has one inflection point.

The fifth lens element E5 with positive refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The image-side surface of the fifth lens element E5 has one critical point in an off-axis region thereof. Additionally, the object-side surface of the fifth lens element E5 and the image-side surface of the fourth lens element E4 are cemented to each other.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the optical system lens assembly. The image sensor IS is disposed on or near the image surface IMG of the optical system lens assembly.

The detailed optical data of the 3rd embodiment are shown in Table 3A and the aspheric surface data are shown in Table 3B below.

TABLE 3A
3rd Embodiment
f = 3.70 mm, Fno = 1.80, HFOV = 61.0 deg.

| | | | | | | Index | | | Focal Length | |
|---|---|---|---|---|---|---|---|---|---|---|
| Surface # | | Curvature Radius | | Thickness | Material | 940.0 nm | d-line | Abbe # | 940.0 nm | d-line |
| 0 | Object | Plano | | Infinity | | | | | | |
| 1 | Lens 1 | 13.4484 | (ASP) | 0.715 | Plastic | 1.635 | 1.661 | 20.4 | −5.25 | −5.04 |
| 2 | | 2.6158 | (ASP) | 0.809 | | | | | | |
| 3 | Ape. Stop | Plano | | 0.132 | | | | | | |
| 4 | Lens 2 | —6.4685 | (ASP) | 2.100 | Plastic | 1.640 | 1.652 | 58.4 | 13.71 | 13.43 |
| 5 | | —4.1962 | (ASP) | 0.176 | | | | | | |
| 6 | Lens 3 | 19.0680 | (ASP) | 1.860 | Glass | 1.610 | 1.620 | 60.3 | 8.41 | 8.27 |
| 7 | | —6.7552 | (ASP) | −0.348 | | | | | | |
| 8 | Stop | Plano | | 0.771 | | | | | | |
| 9 | Lens 4 | 6.4894 | (ASP) | 2.470 | Plastic | 1.536 | 1.545 | 56.0 | 5.53 | 5.45 |
| 10 | | —4.7365 | (ASP) | 0.008 | Cement | 1.537 | — | 43.9 | — | — |
| 11 | Lens 5 | —5.7748 | (ASP) | 2.296 | Plastic | 1.644 | 1.671 | 19.5 | 9.44 | 8.99 |
| 12 | | —3.4214 | (ASP) | 0.050 | | | | | | |
| 13 | Lens 6 | 5.2069 | (ASP) | 0.600 | Plastic | 1.644 | 1.671 | 19.5 | −4.98 | −4.79 |
| 14 | | 1.8951 | (ASP) | 1.183 | | | | | | |

| | | | | | | | | | |
|---|---|---|---|---|---|---|---|---|---|
| 15 | Filter | Plano | 0.210 | Glass | 1.508 | 1.516 | 64.1 | — | — |
| 16 | | Plano | 0.917 | | | | | | |
| 17 | Image | Plano | — | | | | | | |

Note:
Reference wavelength is 940.0 nm.
An effective radius of the stop S1 (Surface 8) is 2.236 mm.
When reference wavelength is 587.6 nm (d-line), fd = 3.64 mm, HFOVd = 61.5 degrees, and TLd = 13.955 mm.

TABLE 3B
Aspheric Coefficients

| Surface # | 1 | 2 | 4 | 5 | 6 | 7 |
|---|---|---|---|---|---|---|
| k= | 7.04357E+00 | 2.15524E+00 | −9.90000E+01 | −1.48584E−01 | 3.73154E+00 | 3.56611E−01 |
| A4= | 1.55544E−02 | 2.00015E−02 | −4.00084E−02 | −3.85298E−03 | −2.68974E−05 | 1.75303E−03 |
| A6= | −2.27772E−03 | 1.82871E−03 | 2.93302E−02 | −4.98760E−05 | −1.47411E−04 | −1.49086E−03 |
| A8= | 1.66053E−04 | −2.26406E−03 | −1.32971E−02 | −6.03644E−05 | 1.37373E−04 | 3.72608E−04 |
| A10= | 1.06415E−05 | 1.01760E−03 | 3.50482E−03 | −5.75970E−06 | −2.27063E−05 | −2.99702E−05 |
| A12= | −4.38274E−06 | − | — | — | — | — |

| Surface # | 9 | 10 | 11 | 12 | 13 | 14 |
|---|---|---|---|---|---|---|
| k= | 2.13629E+00 | −1.85596E+00 | 2.87487E+00 | —2.07670E+01 | 1.80754E+00 | −6.27838E+00 |
| A4= | 3.73673E−03 | −1.98982E−03 | −9.33403E−03 | 6.71309E−03 | −1.61990E−02 | −5.02835E−03 |
| A6= | −2.18217E−03 | 8.87755E−04 | 3.94062E−03 | −1.53049E−03 | −2.53894E−05 | −5.36978E−04 |
| A8= | 4.91074E−04 | 3.52358E−04 | −1.54059E−04 | 5.84700E−04 | 1.42112E−04 | 1.82179E−04 |
| A10= | −6.07002E−05 | −1.38187E−04 | −8.43201E−05 | −1.30078E−04 | −3.09582E−05 | −4.33700E−05 |
| A12= | 4.33555E−06 | 1.00333E−05 | 8.20325E−06 | 1.32901E−05 | −4.24234E−06 | 5.61253E−06 |
| A14= | −1.55224E−07 | — | — | −4.82127E−07 | 1.30728E−06 | −3.49678E−07 |
| A16= | — | — | — | — | −7.58304E−08 | 8.07924E−09 |

In the 3rd embodiment, the equation of the aspheric surface profiles of the aforementioned lens elements is the same as the equation of the 1st embodiment. Also, the definitions of these parameters shown in Table 3C below are the same as those stated in the 1st embodiment with corresponding values for the 3rd embodiment, so an explanation in this regard will not be provided again.

Moreover, these parameters can be calculated from Table 3A and Table 3B as the following values and satisfy the following conditions:

TABLE 3C
Values of Optical and Physical Parameters/Definitions

| | | | |
|---|---|---|---|
| fd [mm] | 3.64 | CT1/CT2 | 0.34 |
| Fno | 1.80 | CT2/T12 | 2.23 |
| HFOVd [deg.] | 61.5 | CT4/CT6 | 4.12 |
| TLd/fd | 3.83 | CT5/CT3 | 1.23 |
| TLd/ImgH | 3.82 | ΣAT/ΣCT | 0.16 |
| SD/TD | 0.87 | MaxAT/CT5 | 0.41 |
| fd/f5d | 0.40 | V1d | 20.4 |
| f4d/f6d | −1.14 | V2d/V1d | 2.86 |
| \|f6d/f5d\| | 0.53 | V5d + V6d | 39.0 |
| fd/R11 + fd/R12 | 2.62 | Y1R1d/Y3R2d | 0.97 |
| (R1 + R12)/(R1 − R12) | 1.33 | Y1R1d/ImgH | 0.60 |
| (R5 + R6)/(R5 − R6) | 0.48 | CRAd [deg.] | 13.5 |
| (R7 + R8)/(R7 − R8) | 0.16 | — | — |

### 4th Embodiment

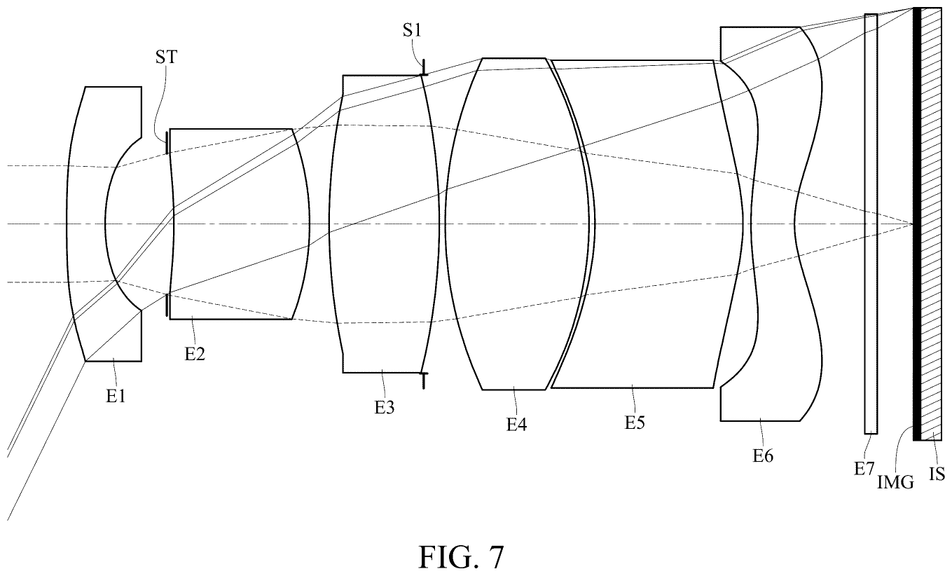

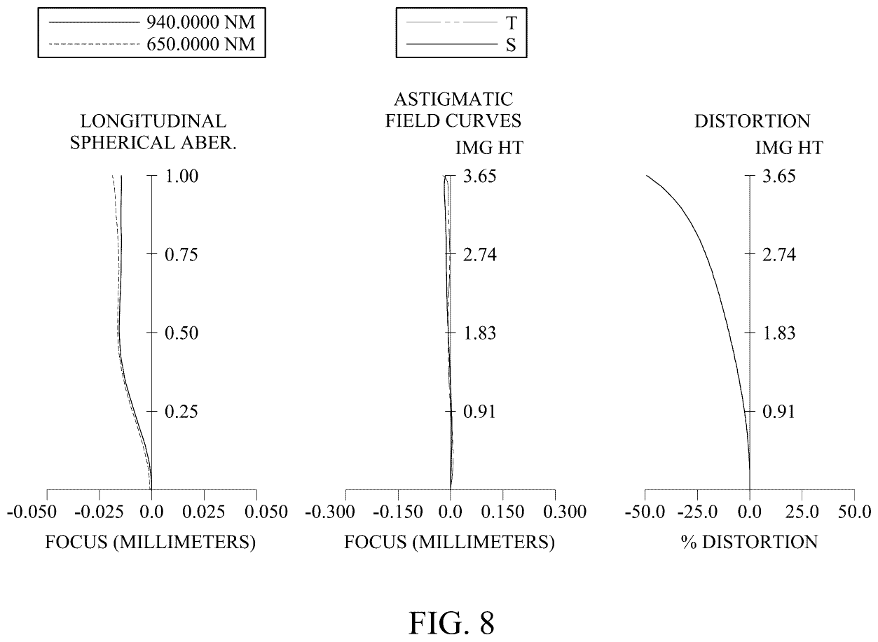

FIG. 7 is a schematic view of an image capturing unit according to the 4th embodiment of the present disclosure. FIG. 8 shows, in order from left to right, spherical aberration curves, astigmatic field curves and a distortion curve of the image capturing unit according to the 4th embodiment. In FIG. 7, the image capturing unit 4 includes the optical system lens assembly (its reference numeral is omitted) of the present disclosure and an image sensor IS. The optical system lens assembly includes, in order from an object side to an image side along an optical path, a first lens element E1, an aperture stop ST, a second lens element E2, a third lens element E3, a stop S1, a fourth lens element E4, a fifth lens element E5, a sixth lens element E6, a filter E7 and an image surface IMG. The optical system lens assembly includes six lens elements (E1, E2, E3, E4, E5 and E6) with no additional lens element disposed between each of the adjacent six lens elements.

The first lens element E1 with negative refractive power has an object-side surface being convex in a paraxial region thereof and an image-side surface being concave in a paraxial region thereof. The first lens element E1 is made of plastic material and has the object-side surface and the image-side surface being both aspheric. The object-side surface of the first lens element E1 has one inflection point.

The second lens element E2 with positive refractive power has an object-side surface being concave in a paraxial region thereof and an image-side surface being convex in a paraxial region thereof. The second lens element E2 is made of plastic material and has the object-side surface and the image-side surface being both aspheric. The object-side surface of the second lens element E2 has one inflection point. The image-side surface of the second lens element E2 has one inflection point.

The third lens element E3 with positive refractive power has an object-side surface being convex in a paraxial region thereof and an image-side surface being convex in a paraxial region thereof. The third lens element E3 is made of glass material and has the object-side surface and the image-side surface being both spherical.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric.

The fifth lens element E5 with positive refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the optical system lens assembly. The image sensor IS is disposed on or near the image surface IMG of the optical system lens assembly.

The detailed optical data of the 4th embodiment are shown in Table 4A and the aspheric surface data are shown in Table 4B below.

TABLE 4A
4th Embodiment
f = 3.54 mm, Fno = 1.80, HFOV = 63.9 deg.

| | | | | | | Index | | | Focal Length | |
|---|---|---|---|---|---|---|---|---|---|---|
| Surface # | | Curvature Radius | | Thickness | Material | 940.0 nm | d-line | Abbe # | 940.0 nm | d-line |
| 0 | Object | Plano | | Infinity | | | | | | |
| 1 | Lens 1 | 24.8089 | (ASP) | 0.650 | Plastic | 1.644 | 1.671 | 19.5 | −5.34 | −5.12 |
| 2 | | 2.9883 | (ASP) | 1.042 | | | | | | |
| 3 | Ape. Stop | Plano | | 0.118 | | | | | | |
| 4 | Lens 2 | −8.0871 | (ASP) | 2.291 | Plastic | 1.536 | 1.545 | 56.0 | 16.02 | 15.73 |
| 5 | | −4.5767 | (ASP) | 0.329 | | | | | | |
| 6 | Lens 3 | 10.3598 | (SPH) | 1.860 | Glass | 1.684 | 1.697 | 55.5 | 7.86 | 7.72 |
| 7 | | −10.3598 | (SPH) | −0.263 | | | | | | |
| 8 | Stop | Plano | | 0.363 | | | | | | |
| 9 | Lens 4 | 6.5564 | (ASP) | 2.427 | Plastic | 1.536 | 1.545 | 56.0 | 5.89 | 5.80 |
| 10 | | −5.2976 | (ASP) | 0.100 | | | | | | |
| 11 | Lens 5 | −4.1462 | (ASP) | 2.499 | Plastic | 1.644 | 1.671 | 19.5 | 9.06 | 8.59 |
| 12 | | −2.9950 | (ASP) | 0.135 | | | | | | |
| 13 | Lens 6 | 5.2390 | (ASP) | 0.734 | Plastic | 1.644 | 1.671 | 19.5 | −4.81 | −4.62 |
| 14 | | 1.8391 | (ASP) | 1.187 | | | | | | |

| | | | | | | | | | |
|---|---|---|---|---|---|---|---|---|---|
| 15 | Filter | Plano | 0.210 | Glass | 1.508 | 1.516 | 64.1 | — | — |
| 16 | | Plano | 0.613 | | | | | | |
| 17 | Image | Plano | — | | | | | | |

Note:
Reference wavelength is 940.0 nm.
An effective radius of the stop S1 (Surface 8) is 2.520 mm.
When reference wavelength is 587.6 nm (d-line), fd = 3.47 mm, HFOVd = 65.6 degrees, and TLd = 14.300 mm.

TABLE 4B
Aspheric Coefficients

| Surface # | 1 | 2 | 4 | 5 | 9 |
|---|---|---|---|---|---|
| k= | 9.00000E+01 | 2.53571E+00 | −9.00000E+01 | −1.32370E+00 | 1.79678E+00 |
| A4= | 1.38719E−02 | 1.80910E−02 | −1.34967E−02 | −3.24535E−03 | −7.51465E−04 |
| A6= | −1.66427E−03 | 2.35448E−03 | 1.00208E−02 | −9.24541E−06 | 2.82712E−05 |
| A8= | 6.80235E−05 | −8.94957E−04 | −1.44763E−03 | 3.72020E−05 | −2.01508E−05 |
| A10= | 9.35577E−07 | 3.65610E−04 | 3.95871E−04 | −1.34643E−05 | 2.65484E−06 |
| A12= | −1.41008E−06 | −2.09442E−14 | −1.29206E−07 | 4.85264E−06 | −2.63178E−07 |
| A14= | — | — | — | — | 9.35044E−09 |

| Surface # | 10 | 11 | 12 | 13 | 14 |
|---|---|---|---|---|---|
| k= | 2.09138E−01 | 5.52631E−01 | −1.24363E+01 | 1.98252E+00 | −5.83818E+00 |
| A4= | 2.60978E−03 | 1.09412E−02 | 5.01900E−03 | −2.21256E−02 | −1.27955E−02 |
| A6= | −2.50129E−05 | −1.26387E−03 | −1.06121E−03 | −7.22343E−05 | 9.29603E−04 |
| A8= | −9.28812E−05 | 1.34454E−04 | 1.33975E−04 | 4.24969E−05 | −7.35281E−05 |
| A10= | 1.32937E−05 | −4.67200E−06 | −1.13832E−05 | −2.57418E−05 | 2.88522E−06 |
| A12= | −4.41193E−07 | 9.85480E−08 | 8.20355E−07 | 1.85650E−06 | −8.18265E−08 |
| A14= | −6.10451E−09 | 1.04877E−08 | −3.25223E−08 | −4.51841E−08 | −5.60050E−09 |
| A16= | — | — | — | −1.48694E−09 | 4.59535E−10 |

In the 4th embodiment, the equation of the aspheric surface profiles of the aforementioned lens elements is the same as the equation of the 1st embodiment. Also, the definitions of these parameters shown in Table 4C below are the same as those stated in the 1st embodiment with corresponding values for the 4th embodiment, so an explanation in this regard will not be provided again.

Moreover, these parameters can be calculated from Table 4A and Table 4B as the following values and satisfy the following conditions:

TABLE 4C
Values of Optical and Physical Parameters/Definitions

| | | | |
|---|---|---|---|
| fd [mm] | 3.47 | CT1/CT2 | 0.28 |
| Fno | 1.80 | CT2/T12 | 1.98 |
| HFOVd [deg.] | 65.6 | CT4/CT6 | 3.31 |
| TLd/fd | 4.12 | CT5/CT3 | 1.34 |
| TLd/ImgH | 3.92 | ΣAT/ΣCT | 0.17 |
| SD/TD | 0.86 | MaxAT/CT5 | 0.46 |
| fd/f5d | 0.40 | V1d | 19.5 |
| f4d/f6d | −1.26 | V2d/V1d | 2.87 |
| f6d/f5d\| | 0.54 | V5d + V6d | 39.0 |
| fd/R11 + fd/R12 | 2.55 | Y1R1d/Y3R2d | 0.92 |
| (R1 + R12)/(R1 − R12) | 1.16 | Y1R1d/ImgH | 0.63 |
| (R5 + R6)/(R5 − R6) | 0.00 | CRAd [deg.] | 12.0 |
| (R7 + R8)/(R7 − R8) | 0.11 | — | — |

### 5th Embodiment

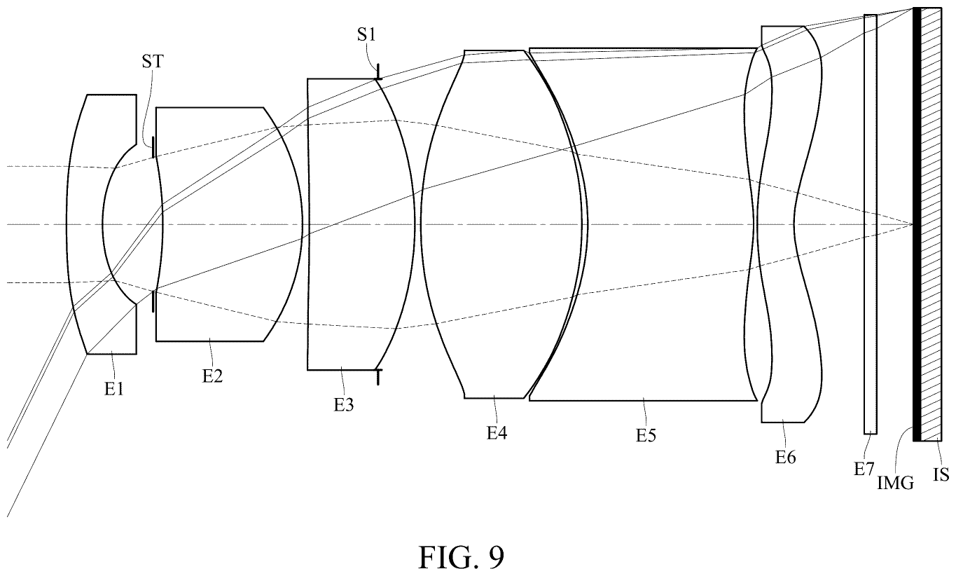

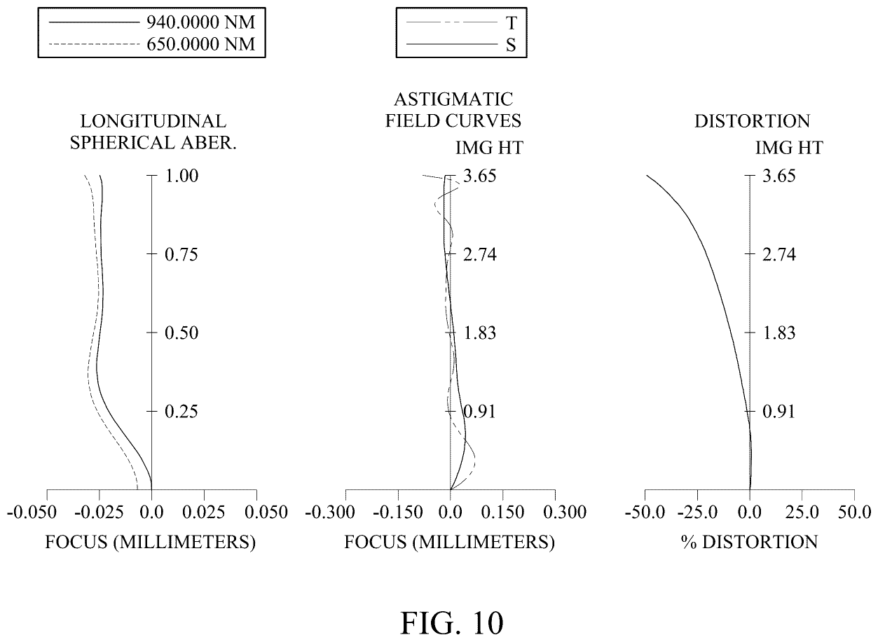

FIG. 9 is a schematic view of an image capturing unit according to the 5th embodiment of the present disclosure. FIG. 10 shows, in order from left to right, spherical aberration curves, astigmatic field curves and a distortion curve of the image capturing unit according to the 5th embodiment. In FIG. 9, the image capturing unit 5 includes the optical system lens assembly (its reference numeral is omitted) of the present disclosure and an image sensor IS. The optical system lens assembly includes, in order from an object side to an image side along an optical path, a first lens element E1, an aperture stop ST, a second lens element E2, a third lens element E3, a stop S1, a fourth lens element E4, a fifth lens element E5, a sixth lens element E6, a filter E7 and an image surface IMG. The optical system lens assembly includes six lens elements (E1, E2, E3, E4, E5 and E6) with no additional lens element disposed between each of the adjacent six lens elements.

The first lens element E1 with negative refractive power has an object-side surface being convex in a paraxial region thereof and an image-side surface being concave in a paraxial region thereof. The first lens element E1 is made of plastic material and has the object-side surface and the image-side surface being both aspheric. The object-side surface of the first lens element E1 has one inflection point.

The second lens element E2 with positive refractive power has an object-side surface being concave in a paraxial region thereof and an image-side surface being convex in a paraxial region thereof. The second lens element E2 is made of plastic material and has the object-side surface and the image-side surface being both aspheric. The object-side surface of the second lens element E2 has one inflection point.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric. The object-side surface of the third lens element E3 has two inflection points.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point.

The fifth lens element E5 with positive refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has one inflection point. The image-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the optical system lens assembly. The image sensor IS is disposed on or near the image surface IMG of the optical system lens assembly.

The detailed optical data of the 5th embodiment are shown in Table 5A and the aspheric surface data are shown in Table 5B below.

TABLE 5A
5th Embodiment
f = 3.54 mm, Fno = 1.80, HFOV = 63.8 deg.

| | | | | | | Index | | | Focal Length | |
|---|---|---|---|---|---|---|---|---|---|---|
| Surface # | | Curvature Radius | | Thickness | Material | 940.0 nm | d-line | Abbe # | 940.0 nm | d-line |
| 0 | Object | Plano | | Infinity | | | | | | |
| 1 | Lens 1 | 14.9879 | (ASP) | 0.608 | Plastic | 1.594 | 1.614 | 25.7 | −5.23 | −5.06 |
| 2 | | 2.5330 | (ASP) | 0.855 | | | | | | |
| 3 | Ape. Stop | Plano | | 0.163 | | | | | | |
| 4 | Lens 2 | −5.8509 | (ASP) | 2.359 | Plastic | 1.536 | 1.545 | 56.0 | 11.01 | 10.81 |
| 5 | | −3.3516 | (ASP) | 0.114 | | | | | | |
| 6 | Lens 3 | −66.6667 | (ASP) | 1.783 | Plastic | 1.536 | 1.545 | 56.0 | 10.05 | 9.89 |
| 7 | | −5.0316 | (ASP) | −0.622 | | | | | | |
| 8 | Stop | Plano | | 0.722 | | | | | | |
| 9 | Lens 4 | 5.7254 | (ASP) | 2.719 | Plastic | 1.536 | 1.545 | 56.0 | 5.58 | 5.49 |
| 10 | | −5.2182 | (ASP) | 0.100 | | | | | | |
| 11 | Lens 5 | −3.8532 | (ASP) | 2.800 | Plastic | 1.644 | 1.671 | 19.5 | 8.58 | 8.12 |
| 12 | | −2.9159 | (ASP) | 0.061 | | | | | | |
| 13 | Lens 6 | 5.6121 | (ASP) | 0.619 | Plastic | 1.617 | 1.639 | 23.5 | −4.76 | −4.60 |
| 14 | | 1.8462 | (ASP) | 1.188 | | | | | | |

| | | | | | | | | | |
|---|---|---|---|---|---|---|---|---|---|
| 15 | Filter | Plano | 0.210 | Glass | 1.508 | 1.516 | 64.1 | — | — |
| 16 | | Plano | 0.621 | | | | | | |
| 17 | Image | Plano | — | | | | | | |

Note:
Reference wavelength is 940.0 nm.
An effective radius of the stop S1 (Surface 8) is 2.456 mm.
When reference wavelength is 587.6 nm (d-line), fd = 3.47 mm, HFOVd = 64.5 degrees, and TLd = 14.293 mm.

TABLE 5B
Aspheric Coefficients

| Surface # | 1 | 2 | 4 | 5 | 6 | 7 |
|---|---|---|---|---|---|---|
| k= | 1.68097E+01 | 2.08673E+00 | −9.90000E+01 | −6.17188E−01 | −9.90000E+01 | 3.85753E−01 |
| A4= | 1.71346E−02 | 1.62074E−02 | −5.37071E−02 | −8.84151E−03 | −5.79465E−03 | 7.66405E−04 |
| A6= | −3.54500E−03 | −9.30419E−04 | 3.92243E−02 | 3.46555E−03 | 4.00632E−03 | −2.44029E−05 |
| A8= | 6.46597E−04 | 7.40319E−05 | −1.84001E−02 | −8.58552E−04 | −1.00332E−03 | −6.96384E−05 |
| A10= | −9.48410E−05 | −5.92117E−04 | 4.72881E−03 | 7.50556E−05 | 1.28785E−04 | 1.63258E−05 |
| A12= | 5.44460E−06 | — | — | — | −7.96805E−06 | −1.55593E−06 |

| Surface # | 9 | 10 | 11 | 12 | 13 | 14 |
|---|---|---|---|---|---|---|
| k= | 1.30290E+00 | 6.58895E−01 | 4.72405E−01 | −2.59238E+01 | 2.17898E+00 | −8.84278E+00 |
| A4= | 1.14625E−03 | −1.02398E−02 | 2.71899E−03 | 2.26220E−02 | 8.75219E−03 | −3.50086E−03 |
| A6= | −2.05101E−04 | 5.84538E−03 | 2.32530E−03 | −6.89227E−03 | −1.11091E−02 | −7.92827E−04 |
| A8= | −1.16362E−05 | −1.31503E−03 | −5.70079E−04 | 1.11114E−03 | 2.69471E−03 | −2.59098E−04 |
| A10= | −4.71828E−06 | 1.32731E−04 | 5.57725E−05 | −4.59517E−05 | −4.18795E−04 | 1.45585E−04 |
| A12= | 1.30294E−06 | −4.98337E−06 | −1.42798E−06 | −5.35292E−06 | 5.01401E−05 | −2.26082E−05 |
| A14= | −1.05146E−07 | — | — | 4.25227E−07 | −4.11379E−06 | 1.47282E−06 |
| A16= | — | — | — | — | 1.46754E−07 | −3.54494E−08 |

In the 5th embodiment, the equation of the aspheric surface profiles of the aforementioned lens elements is the same as the equation of the 1st embodiment. Also, the definitions of these parameters shown in Table 5C below are the same as those stated in the 1st embodiment with corresponding values for the 5th embodiment, so an explanation in this regard will not be provided again.

Moreover, these parameters can be calculated from Table 5A and Table 5B as the following values and satisfy the following conditions:

TABLE 5C
Values of Optical and Physical Parameters/Definitions

| | | | |
|---|---|---|---|
| fd [mm] | 3.47 | CT1/CT2 | 0.26 |
| Fno | 1.80 | CT2/T12 | 2.32 |
| HFOVd [deg.] | 64.5 | CT4/CT6 | 4.39 |
| TLd/fd | 4.12 | CT5/CT3 | 1.57 |
| TLd/ImgH | 3.92 | ΣAT/ΣCT | 0.13 |
| SD/TD | 0.88 | MaxAT/CT5 | 0.36 |
| fd/f5d | 0.43 | V1d | 25.7 |
| f4d/f6d | −1.19 | V2d/V1d | 2.18 |
| \|f6d/f5d\| | 0.57 | V5d + V6d | 43.0 |
| fd/R11 + fd/R12 | 2.50 | Y1R1d/Y3R2d | 0.89 |
| (R1 + R12)/(R1 − R12) | 1.28 | Y1R1d/ImgH | 0.60 |
| (R5 + R6)/(R5 − R6) | 1.16 | CRAd [deg.] | 12.0 |
| (R7 + R8)/(R7 − R8) | 0.05 | — | — |

### 6th Embodiment

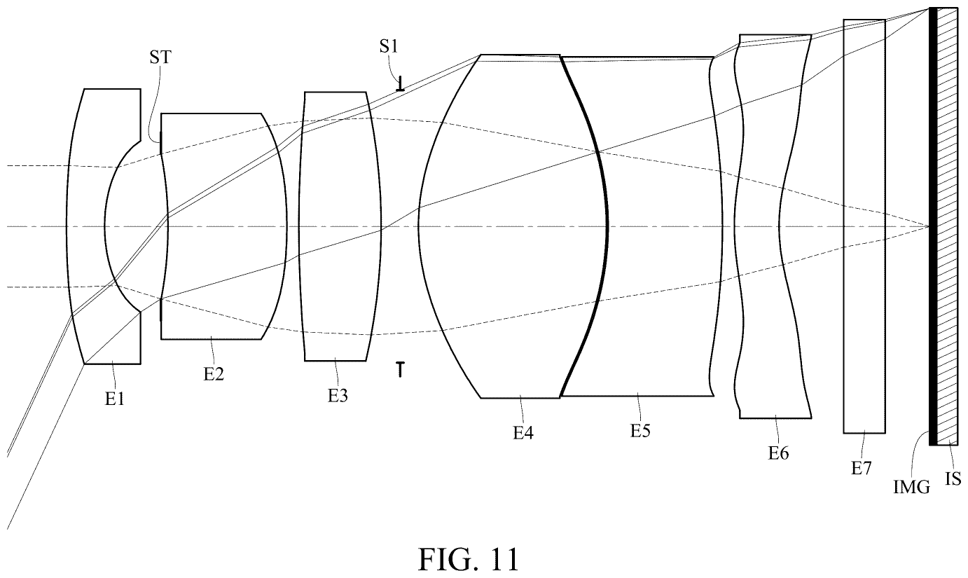

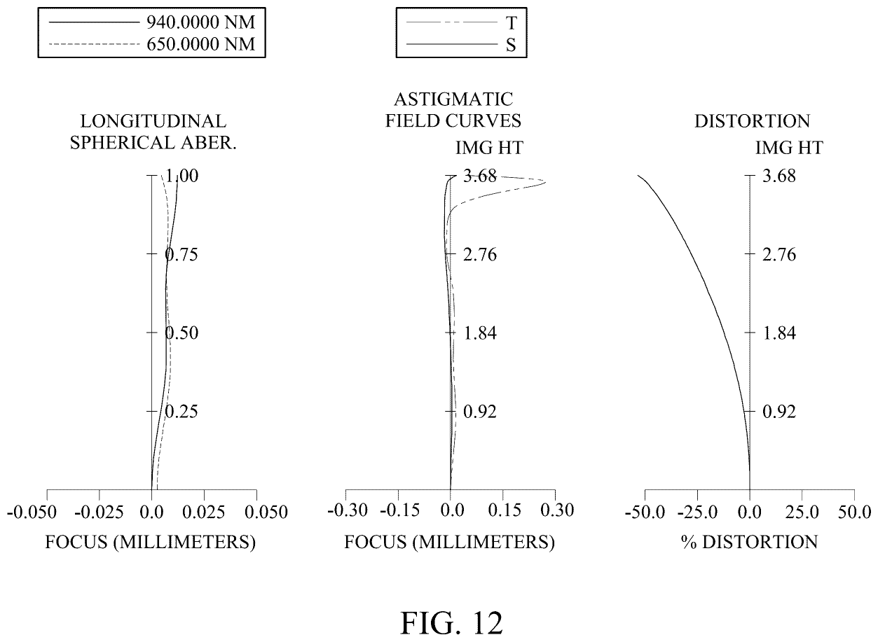

FIG. 11 is a schematic view of an image capturing unit according to the 6th embodiment of the present disclosure. FIG. 12 shows, in order from left to right, spherical aberration curves, astigmatic field curves and a distortion curve of the image capturing unit according to the 6th embodiment. In FIG. 11, the image capturing unit 6 includes the optical system lens assembly (its reference numeral is omitted) of the present disclosure and an image sensor IS. The optical system lens assembly includes, in order from an object side to an image side along an optical path, a first lens element E1, an aperture stop ST, a second lens element E2, a third lens element E3, a stop S1, a fourth lens element E4, a fifth lens element E5, a sixth lens element E6, a filter E7 and an image surface IMG. The optical system lens assembly includes six lens elements (E1, E2, E3, E4, E5 and E6) with no additional lens element disposed between each of the adjacent six lens elements.

The first lens element E1 with negative refractive power has an object-side surface being convex in a paraxial region thereof and an image-side surface being concave in a paraxial region thereof. The first lens element E1 is made of plastic material and has the object-side surface and the image-side surface being both aspheric. The object-side surface of the first lens element E1 has one inflection point.

The second lens element E2 with positive refractive power has an object-side surface being concave in a paraxial region thereof and an image-side surface being convex in a paraxial region thereof. The second lens element E2 is made of plastic material and has the object-side surface and the image-side surface being both aspheric. The object-side surface of the second lens element E2 has one inflection point.

The third lens element E3 with positive refractive power has an object-side surface being convex in a paraxial region thereof and an image-side surface being convex in a paraxial region thereof. The third lens element E3 is made of glass material and has the object-side surface and the image-side surface being both spherical.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The image-side surface of the fourth lens element E4 has one inflection point.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The image-side surface of the fifth lens element E5 has one critical point in an off-axis region thereof. Additionally, the object-side surface of the fifth lens element E5 and the image-side surface of the fourth lens element E4 are cemented to each other.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has three inflection points. The object-side surface of the sixth lens element E6 has two critical points in an off-axis region thereof.

The filter E7 is made of glass material and located between the sixth lens element E6 and the image surface IMG, and will not affect the focal length of the optical system lens assembly. The image sensor IS is disposed on or near the image surface IMG of the optical system lens assembly.

The detailed optical data of the 6th embodiment are shown in Table 6A and the aspheric surface data are shown in Table 6B below.

TABLE 6A
6th Embodiment
f = 3.69 mm, Fno = 1.80, HFOV = 65.0 deg.

| | | | | | | Index | | Abbe | Focal Length | |
|---|---|---|---|---|---|---|---|---|---|---|
| Surface # | | Curvature Radius | | Thickness | Material | 940.0 nm | d-line | # | 940.0 nm | d-line |
| 0 | Object | Plano | | Infinity | | | | | | |
| 1 | Lens 1 | 15.9010 | (ASP) | 0.644 | Plastic | 1.644 | 1.671 | 19.5 | −4.99 | −4.79 |
| 2 | | 2.6305 | (ASP) | 0.950 | | | | | | |
| 3 | Ape. Stop | Plano | | 0.119 | | | | | | |
| 4 | Lens 2 | −7.1467 | (ASP) | 2.007 | Plastic | 1.536 | 1.545 | 56.0 | 136.26 | 132.64 |
| 5 | | −7.1476 | (ASP) | 0.202 | | | | | | |
| 6 | Lens 3 | 23.0440 | (SPH) | 1.390 | Glass | 1.757 | 1.772 | 49.6 | 9.43 | 9.25 |
| 7 | | −10.0774 | (SPH) | 0.322 | | | | | | |
| 8 | Stop | Plano | | 0.307 | | | | | | |
| 9 | Lens 4 | 3.5724 | (ASP) | 3.173 | Plastic | 1.536 | 1.545 | 56.0 | 4.36 | 4.29 |
| 10 | | −4.6527 | (ASP) | 0.030 | Cement | 1.477 | — | 53.2 | — | — |
| 11 | Lens 5 | −4.6527 | (ASP) | 1.929 | Plastic | 1.644 | 1.671 | 19.5 | −12.59 | −12.10 |
| 12 | | −12.7074 | (ASP) | 0.201 | | | | | | |
| 13 | Lens 6 | 4.1182 | (ASP) | 0.754 | Plastic | 1.594 | 1.614 | 25.7 | −21.12 | −20.55 |
| 14 | | 2.8886 | (ASP) | 1.093 | | | | | | |

| | | | | | | | | | |
|---|---|---|---|---|---|---|---|---|---|
| 15 | Filter | Plano | 0.700 | Glass | 1.508 | 1.516 | 64.1 | — | — |
| 16 | | Plano | 0.751 | | | | | | |
| 17 | Image | Plano | — | | | | | | |

Note:
Reference wavelength is 940.0 nm.
An effective radius of the stop S1 (Surface 8) is 2.300 mm.
When reference wavelength is 587.6 nm (d-line), fd = 3.63 mm, HFOVd = 66.6 degrees, and TLd = 14.582 mm.

TABLE 6B
Aspheric Coefficients

| Surface # | 1 | 2 | 4 | 5 | 9 |
|---|---|---|---|---|---|
| k= | 9.63824E+00 | 1.78504E+00 | −5.92614E+00 | 3.33938E+00 | −5.84628E−01 |
| A4= | 5.51316E−03 | 3.30153E−03 | −1.11454E−02 | −1.33452E−02 | −4.91860E−03 |
| A6= | 3.70153E−05 | 3.96834E−03 | 3.97219E−03 | 5.18393E−04 | 3.25406E−04 |
| A8= | −1.04157E−04 | −2.95926E−03 | −1.80151E−03 | 1.81303E−05 | −1.77500E−05 |
| A10= | 2.63674E−05 | 1.21070E−03 | 9.86255E−04 | −3.65676E−05 | 4.74155E−07 |
| A12= | −3.19123E−06 | — | −1.29206E−07 | 4.79610E−06 | 2.74399E−08 |
| A14= | — | — | — | — | −1.44562E−09 |
| A16= | — | — | — | — | −3.23075E−17 |

| Surface # | 10 | 11 | 12 | 13 | 14 |
|---|---|---|---|---|---|
| k= | 9.69220E−01 | 9.69220E−01 | −7.00809E+01 | −1.18362E+00 | −9.28154E−01 |
| A4= | 4.91389E−03 | 4.91389E−03 | −2.96124E−03 | −2.45993E−02 | −2.97006E−02 |
| A6= | −3.21128E−04 | −3.21128E−04 | 1.73434E−04 | −1.21802E−06 | 1.63609E−03 |
| A8= | −5.06711E−05 | −5.06711E−05 | −9.02961E−06 | 8.48886E−05 | 6.07743E−05 |
| A10= | 1.98711E−05 | 1.98711E−05 | −1.59793E−06 | 1.94832E−05 | 2.76037E−07 |
| A12= | −8.99655E−07 | −8.99655E−07 | 7.05724E−07 | −1.16699E−06 | −6.22179E−07 |
| A14= | −2.37672E−15 | −2.37672E−15 | 2.18839E−08 | −1.72433E−08 | 1.12382E−09 |
| A16= | −3.01197E−17 | −3.01197E−17 | −2.88373E−17 | −5.94929E−10 | 7.53360E−10 |

In the 6th embodiment, the equation of the aspheric surface profiles of the aforementioned lens elements is the same as the equation of the 1st embodiment. Also, the definitions of these parameters shown in Table 6C below are the same as those stated in the 1st embodiment with corresponding values for the 6th embodiment, so an explanation in this regard will not be provided again.

Moreover, these parameters can be calculated from Table 6A and Table 6B as the following values and satisfy the following conditions:

TABLE 6C
Values of Optical and Physical Parameters/Definitions

| | | | |
|---|---|---|---|
| fd [mm] | 3.63 | CT1/CT2 | 0.32 |
| Fno | 1.80 | CT2/T12 | 1.88 |
| HFOVd [deg.] | 66.6 | CT4/CT6 | 4.21 |
| TLd/fd | 4.02 | CT5/CT3 | 1.39 |
| TLd/ImgH | 3.96 | ΣAT/ΣCT | 0.22 |
| SD/TD | 0.87 | MaxAT/CT5 | 0.55 |
| fd/f5d | −0.30 | V1d | 19.5 |
| f4d/f6d | −0.21 | V2d/V1d | 2.87 |
| \|f6d/f5d\| | 1.70 | V5d + V6d | 45.2 |
| fd/R11 + fd/R12 | 2.14 | Y1R1d/Y3R2d | 1.02 |
| (R1 + R12)/(R1 − R12) | 1.44 | Y1R1d/ImgH | 0.63 |
| (R5 + R6)/(R5 − R6) | 0.39 | CRAd [deg.] | 16.6 |
| (R7 + R8)/(R7 − R8) | −0.13 | — | — |

### 7th Embodiment

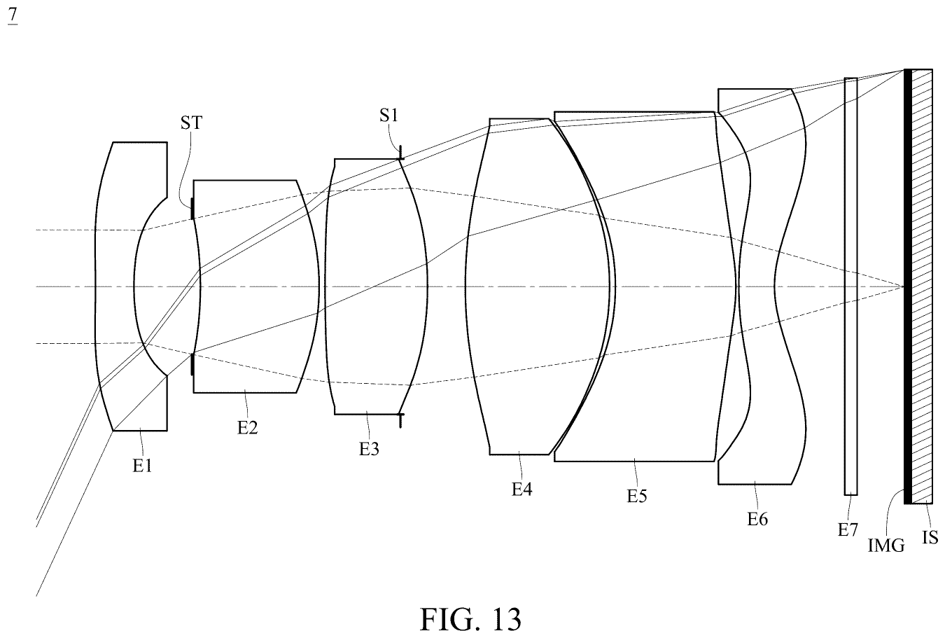

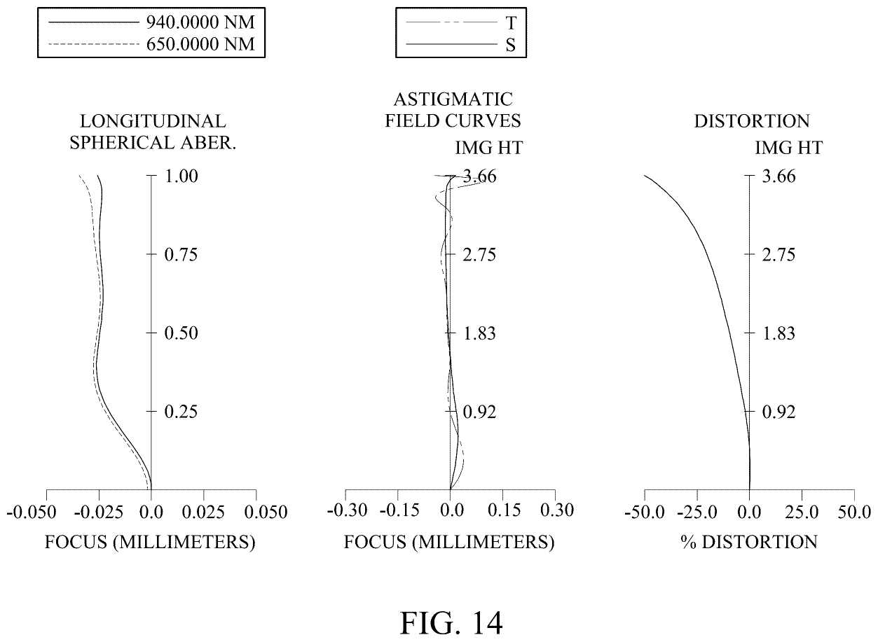

FIG. 13 is a schematic view of an image capturing unit according to the 7th embodiment of the present disclosure. FIG. 14 shows, in order from left to right, spherical aberration curves, astigmatic field curves and a distortion curve of the image capturing unit according to the 7th embodiment. In FIG. 13, the image capturing unit 7 includes the optical system lens assembly (its reference numeral is omitted) of the present disclosure and an image sensor IS. The optical system lens assembly includes, in order from an object side to an image side along an optical path, a first lens element E1, an aperture stop ST, a second lens element E2, a third lens element E3, a stop S1, a fourth lens element E4, a fifth lens element E5, a sixth lens element E6, a filter E7 and an image surface IMG. The optical system lens assembly includes six lens elements (E1, E2, E3, E4, E5 and E6) with no additional lens element disposed between each of the adjacent six lens elements.

The first lens element E1 with negative refractive power has an object-side surface being concave in a paraxial region thereof and an image-side surface being concave in a paraxial region thereof. The first lens element E1 is made of plastic material and has the object-side surface and the image-side surface being both aspheric. The object-side surface of the first lens element E1 has two inflection points. The object-side surface of the first lens element E1 has one critical point in an off-axis region thereof.

The second lens element E2 with positive refractive power has an object-side surface being concave in a paraxial region thereof and an image-side surface being convex in a paraxial region thereof. The second lens element E2 is made of glass material and has the object-side surface and the image-side surface being both aspheric.

The third lens element E3 with positive refractive power has an object-side surface being convex in a paraxial region thereof and an image-side surface being convex in a paraxial region thereof. The third lens element E3 is made of glass material and has the object-side surface and the image-side surface being both aspheric. The image-side surface of the third lens element E3 has one inflection point.

The fourth lens element E4 with positive refractive power has an object-side surface being convex in a paraxial region thereof and an image-side surface being convex in a paraxial region thereof. The fourth lens element E4 is made of glass material and has the object-side surface and the image-side surface being both aspheric. The object-side surface of the fourth lens element E4 has one inflection point.

The fifth lens element E5 with positive refractive power has an object-side surface being concave in a paraxial region thereof and an image-side surface being convex in a paraxial region thereof. The fifth lens element E5 is made of plastic material and has the object-side surface and the image-side surface being both aspheric. The image-side surface of the fifth lens element E5 has four inflection points.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the optical system lens assembly. The image sensor IS is disposed on or near the image surface IMG of the optical system lens assembly.

The detailed optical data of the 7th embodiment are shown in Table 7A and the aspheric surface data are shown in Table 7B below.

TABLE 7A
7th Embodiment
f = 3.41 mm, Fno = 1.78, HFOV = 65.1 deg.

| | | | | | | Index | | | Focal Length | |
|---|---|---|---|---|---|---|---|---|---|---|
| Surface # | | Curvature Radius | | Thickness | Material | 940.0 nm | d-line | Abbe # | 940.0 nm | d-line |
| 0 | Object | Plano | | Infinity | | | | | | |
| 1 | Lens 1 | −19.3250 | (ASP) | 0.650 | Plastic | 1.594 | 1.614 | 25.7 | −5.69 | −5.50 |
| 2 | | 4.1437 | (ASP) | 0.978 | | | | | | |
| 3 | Ape. Stop | Plano | | 0.144 | | | | | | |
| 4 | Lens 2 | −6.1396 | (ASP) | 2.006 | Glass | 1.648 | 1.659 | 57.4 | 14.55 | 14.25 |
| 5 | | −4.1955 | (ASP) | 0.100 | | | | | | |
| 6 | Lens 3 | 20.9978 | (ASP) | 1.730 | Glass | 1.480 | 1.487 | 70.4 | 9.51 | 9.37 |
| 7 | | −5.6770 | (ASP) | −0.458 | | | | | | |
| 8 | Stop | Plano | | 1.097 | | | | | | |
| 9 | Lens 4 | 7.7065 | (ASP) | 2.435 | Glass | 1.700 | 1.713 | 53.8 | 4.41 | 4.34 |
| 10 | | −4.4840 | (ASP) | 0.100 | | | | | | |
| 11 | Lens 5 | −3.6823 | (ASP) | 2.034 | Plastic | 1.644 | 1.671 | 19.5 | 10.21 | 9.67 |
| 12 | | −2.8704 | (ASP) | 0.050 | | | | | | |
| 13 | Lens 6 | 5.7168 | (ASP) | 0.602 | Plastic | 1.662 | 1.697 | 16.3 | −4.31 | −4.10 |
| 14 | | 1.8230 | (ASP) | 1.188 | | | | | | |

| | | | | | | | | | |
|---|---|---|---|---|---|---|---|---|---|
| 15 | Filter | Plano | 0.210 | Glass | 1.508 | 1.516 | 64.1 | — | — |
| 16 | | Plano | 0.796 | | | | | | |
| 17 | Image | Plano | — | | | | | | |

Note:
Reference wavelength is 940.0 nm.
An effective radius of the stop S1 (Surface 8) is 2.157 mm.
When reference wavelength is 587.6 nm (d-line), fd = 3.38 mm, HFOVd = 65.8 degrees, and TLd = 13.669 mm.

TABLE 7B
Aspheric Coefficients

| Surface # | 1 | 2 | 4 | 5 | 6 | 7 |
|---|---|---|---|---|---|---|
| k= | −9.90000E+01 | 5.05647E+00 | −9.90000E+01 | −1.55124E+00 | 6.50841E+01 | 1.40829E+00 |
| A4= | 2.77356E−02 | 3.39804E−02 | −4.90844E−02 | −1.13297E−02 | −1.26836E−02 | −4.47213E−03 |
| A6= | −5.28349E−03 | 1.75831E−03 | 3.16392E−02 | 6.06778E−03 | 8.35672E−03 | −8.43951E−04 |
| A8= | 7.99032E−04 | −1.85049E−03 | −1.33959E−02 | −1.02331E−03 | −1.74194E−03 | 4.65475E−04 |
| A10= | −7.99594E−05 | 5.65480E−04 | 2.56029E−03 | 3.03259E−05 | 1.83458E−04 | −3.91592E−05 |
| A12= | 3.19289E−06 | — | — | — | −8.71804E−06 | 1.52081E−06 |

| Surface # | 9 | 10 | 11 | 12 | 13 | 14 |
|---|---|---|---|---|---|---|
| k= | 2.43325E−01 | 3.49202E−01 | 3.41219E−01 | −2.01295E+01 | 2.15627E+00 | −7.52945E+00 |
| A4= | 3.62427E−04 | −9.34746E−03 | −8.17709E−03 | 2.51655E−02 | 1.19367E−02 | 2.91594E−03 |
| A6= | −7.71769E−04 | 4.55617E−03 | 5.53662E−03 | −1.27120E−02 | −1.36373E−02 | −2.36481E−03 |
| A8= | 1.84631E−04 | −8.73161E−04 | −9.93280E−04 | 3.53007E−03 | 3.23600E−03 | 9.17631E−05 |
| A10= | −2.28949E−05 | 8.01407E−05 | 9.26148E−05 | −5.78124E−04 | −4.48554E−04 | 4.36386E−05 |
| A12= | 9.30725E−07 | −2.82887E−06 | −3.20517E−06 | 5.16471E−05 | 2.00780E−05 | −8.25198E−06 |
| A14= | 4.47138E−09 | — | — | −1.89912E−06 | 1.88362E−06 | 6.11079E−07 |
| A16= | — | — | — | — | −1.63394E−07 | −1.68865E−08 |

In the 7th embodiment, the equation of the aspheric surface profiles of the aforementioned lens elements is the same as the equation of the 1st embodiment. Also, the definitions of these parameters shown in Table 7C below are the same as those stated in the 1st embodiment with corresponding values for the 7th embodiment, so an explanation in this regard will not be provided again.

Moreover, these parameters can be calculated from Table 7A and Table 7B as the following values and satisfy the following conditions:

TABLE 7C
Values of Optical and Physical Parameters/Definitions

| | | | |
|---|---|---|---|
| fd [mm] | 3.38 | CT1/CT2 | 0.32 |
| Fno | 1.78 | CT2/T12 | 1.79 |
| HFOVd [deg.] | 65.8 | CT4/CT6 | 4.04 |
| TLd/fd | 4.04 | CT5/CT3 | 1.18 |
| TLd/ImgH | 3.73 | ΣAT/ΣCT | 0.21 |
| SD/TD | 0.86 | MaxAT/CT5 | 0.55 |
| fd/f5d | 0.35 | V1d | 25.7 |
| f4d/f6d | −1.06 | V2d/V1d | 2.23 |
| \|f6d/f5d\| | 0.42 | V5d + V6d | 35.8 |
| fd/R11 + fd/R12 | 2.45 | Y1R1d/Y3R2d | 1.13 |
| (R1 + R12)/(R1 − R12) | 0.83 | Y1R1d/ImgH | 0.67 |
| (R5 + R6)/(R5 − R6) | 0.57 | CRAd [deg.] | 12.5 |
| (R7 + R8)/(R7 − R8) | 0.26 | — | — |

### 8th Embodiment

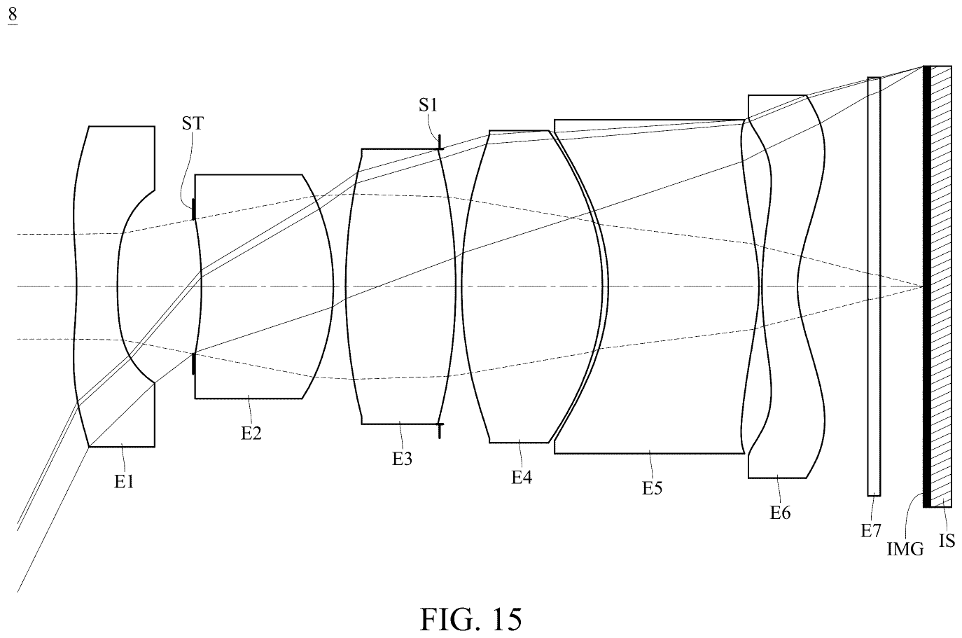

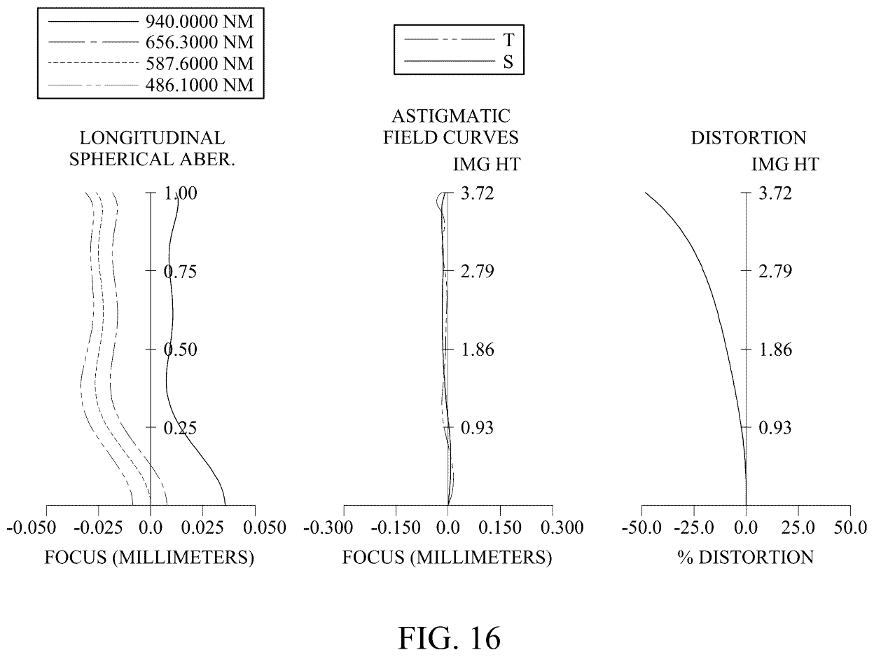

FIG. 15 is a schematic view of an image capturing unit according to the 8th embodiment of the present disclosure. FIG. 16 shows, in order from left to right, spherical aberration curves, astigmatic field curves and a distortion curve of the image capturing unit according to the 8th embodiment. In FIG. 15, the image capturing unit 8 includes the optical system lens assembly (its reference numeral is omitted) of the present disclosure and an image sensor IS. The optical system lens assembly includes, in order from an object side to an image side along an optical path, a first lens element E1, an aperture stop ST, a second lens element E2, a third lens element E3, a stop S1, a fourth lens element E4, a fifth lens element E5, a sixth lens element E6, a filter E7 and an image surface IMG. The optical system lens assembly includes six lens elements (E1, E2, E3, E4, E5 and E6) with no additional lens element disposed between each of the adjacent six lens elements.

The first lens element E1 with negative refractive power has an object-side surface being concave in a paraxial region thereof and an image-side surface being concave in a paraxial region thereof. The first lens element E1 is made of plastic material and has the object-side surface and the image-side surface being both aspheric. The object-side surface of the first lens element E1 has two inflection points. The object-side surface of the first lens element E1 has one critical point in an off-axis region thereof.

The second lens element E2 with positive refractive power has an object-side surface being concave in a paraxial region thereof and an image-side surface being convex in a paraxial region thereof. The second lens element E2 is made of plastic material and has the object-side surface and the image-side surface being both aspheric.

The third lens element E3 with positive refractive power has an object-side surface being convex in a paraxial region thereof and an image-side surface being convex in a paraxial region thereof. The third lens element E3 is made of glass material and has the object-side surface and the image-side surface being both spherical.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point.

The fifth lens element E5 with positive refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has one inflection point. The image-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the optical system lens assembly. The image sensor IS is disposed on or near the image surface IMG of the optical system lens assembly.

The detailed optical data of the 8th embodiment are shown in Table 8A and the aspheric surface data are shown in Table 8B below.

TABLE 8A
8th Embodiment
fd = 3.54 mm, Fno = 2.00, HFOVd = 63.8 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Lens 1 | −5.6932 | (ASP) | 0.689 | Plastic | 1.544 | 56.0 | −5.93 |
| 2 | | 7.7536 | (ASP) | 1.280 | | | | |
| 3 | Ape. Stop | Plano | | 0.139 | | | | |
| 4 | Lens 2 | −6.0470 | (ASP) | 2.227 | Plastic | 1.544 | 56.0 | 14.45 |
| 5 | | −3.8614 | (ASP) | 0.207 | | | | |
| 6 | Lens 3 | 9.0686 | (SPH) | 1.860 | Glass | 1.572 | 57.5 | 8.23 |
| 7 | | −9.0686 | (SPH) | −0.272 | | | | |
| 8 | Stop | Plano | | 0.372 | | | | |
| 9 | Lens 4 | 7.2076 | (ASP) | 2.377 | Plastic | 1.544 | 56.0 | 5.23 |
| 10 | | −4.1601 | (ASP) | 0.100 | | | | |
| 11 | Lens 5 | −3.5150 | (ASP) | 2.544 | Plastic | 1.671 | 19.5 | 9.04 |
| 12 | | −2.8721 | (ASP) | 0.050 | | | | |
| 13 | Lens 6 | 5.6493 | (ASP) | 0.600 | Plastic | 1.671 | 19.5 | −4.27 |
| 14 | | 1.8190 | (ASP) | 1.188 | | | | |

| | | | | | | | |
|---|---|---|---|---|---|---|---|
| 15 | Filter | Plano | 0.210 | Glass | 1.516 | 64.1 | — |
| 16 | | Plano | 0.728 | | | | |
| 17 | Image | Plano | — | | | | |

Note:
Reference wavelength is 587.6 nm (d-line).
An effective radius of the stop S1 (Surface 8) is 2.324 mm.

TABLE 8B
Aspheric Coefficients

| Surface # | 1 | 2 | 4 | 5 | 9 |
|---|---|---|---|---|---|
| k= | −4.03819E+01 | 1.59467E+01 | −9.61295E+01 | −5.50601E−01 | 1.61105E+00 |
| A4= | 2.67541E−02 | 6.24535E−02 | −4.55096E−02 | −2.75771E−03 | 7.44702E−04 |
| A6= | −4.90677E−03 | −7.69622E−03 | 3.36810E−02 | −1.70616E−05 | −4.45699E−05 |
| A8= | 6.49409E−04 | 1.53816E−03 | −1.66516E−02 | −1.94044E−04 | −6.10443E−05 |
| A10= | −5.45243E−05 | 2.32987E−04 | 3.55401E−03 | 2.53531E−05 | 1.43511E−05 |
| A12= | 1.89242E−06 | — | — | — | −2.14577E−06 |
| A14= | — | — | — | — | 1.09736E−07 |

| Surface # | 10 | 11 | 12 | 13 | 14 |
|---|---|---|---|---|---|
| k= | 1.93906E−01 | 3.01090E−01 | −1.88538E+01 | 2.47559E+00 | −8.18192E+00 |
| A4= | −9.28816E−03 | −2.66881E−03 | 1.16365E−02 | −9.90157E−03 | −1.15166E−03 |
| A6= | 4.95194E−03 | 3.72335E−03 | −3.74604E−03 | −1.64315E−03 | −2.22634E−03 |
| A8= | −1.04544E−03 | −7.47344E−04 | 7.74341E−04 | −3.60511E−04 | 4.40611E−04 |
| A10= | 1.10601E−04 | 8.36819E−05 | −9.21937E−05 | 2.16502E−04 | −6.12530E−05 |
| A12= | −4.50168E−06 | −3.17694E−06 | 5.84430E−06 | −4.81720E−05 | 5.10159E−06 |
| A14= | — | — | −1.04770E−07 | 4.87693E−06 | −2.22434E−07 |
| A16= | — | — | — | −1.79069E−07 | 4.19939E−09 |

In the 8th embodiment, the equation of the aspheric surface profiles of the aforementioned lens elements is the same as the equation of the 1st embodiment. Also, the definitions of these parameters shown in Table 8C below are the same as those stated in the 1st embodiment with corresponding values for the 8th embodiment, so an explanation in this regard will not be provided again.

Moreover, these parameters can be calculated from Table 8A and Table 8B as the following values and satisfy the following conditions:

TABLE 8C
Values of Optical and Physical Parameters/Definitions

| | | | |
|---|---|---|---|
| fd [mm] | 3.54 | CT1/CT2 | 0.31 |
| Fno | 2.00 | CT2/T12 | 1.57 |
| HFOVd [deg.] | 63.8 | CT4/CT6 | 3.96 |
| TLd/fd | 4.04 | CT5/CT3 | 1.37 |
| TLd/ImgH | 3.84 | ΣAT/ΣCT | 0.18 |
| SD/TD | 0.84 | MaxAT/CT5 | 0.56 |
| fd/f5d | 0.39 | V1d | 56.0 |
| f4d/f6d | −1.22 | V2d/V1d | 1.00 |
| \|f6d/f5d\| | 0.47 | V5d + V6d | 39.0 |
| fd/R11 + fd/R12 | 2.57 | Y1R1d/Y3R2d | 1.16 |
| (R1 + R12)/(R1 − R12) | 0.52 | Y1R1d/ImgH | 0.73 |
| (R5 + R6)/(R5 − R6) | 0.00 | CRAd [deg.] | 15.9 |
| (R7 + R8)/(R7 − R8) | 0.27 | | − |

### 9th Embodiment

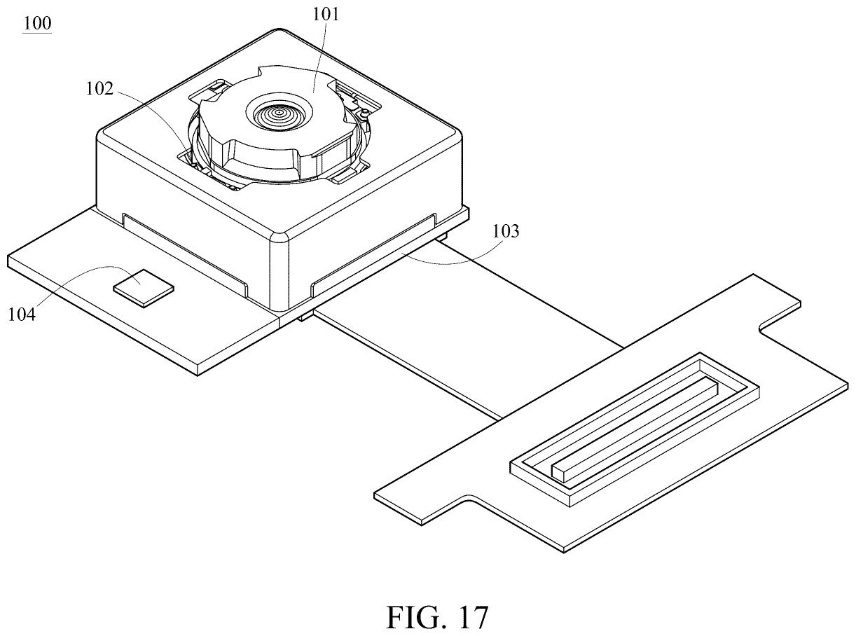

FIG. 17 is a perspective view of an image capturing unit according to the 9th embodiment of the present disclosure. In this embodiment, an image capturing unit 100 is a camera module including a lens unit 101, a driving device 102, an image sensor 103 and an image stabilizer 104. The lens unit 101 includes the optical system lens assembly as disclosed in the 1st embodiment, a barrel and a holder member (their reference numerals are omitted) for holding the optical system lens assembly. However, the lens unit 101 may alternatively be provided with the optical system lens assembly as disclosed in other embodiments of the present disclosure, and the present disclosure is not limited thereto. The imaging light converges in the lens unit 101 of the image capturing unit 100 to generate an image with the driving device 102 utilized for image focusing on the image sensor 103, and the generated image is then digitally transmitted to other electronic component for further processing.

The driving device 102 can have auto focusing functionality, and different driving configurations can be obtained through the usages of voice coil motors (VCM), micro electro-mechanical systems (MEMS), piezoelectric systems or shape memory alloy materials. The driving device 102 is favorable for obtaining a better imaging position of the lens unit 101, so that a clear image of the imaged object can be captured by the lens unit 101 with different object distances. The image sensor 103 (for example, CMOS or CCD), which can feature high photosensitivity and low noise, is disposed on the image surface of the optical system lens assembly to provide higher image quality.

The image stabilizer 104, such as an accelerometer, a gyro sensor and a Hall Effect sensor, is configured to work with the driving device 102 to provide optical image stabilization (OIS). The driving device 102 working with the image stabilizer 104 is favorable for compensating for pan and tilt of the lens unit 101 to reduce blurring associated with motion during exposure. In some cases, the compensation can be provided by electronic image stabilization (EIS) with image processing software, thereby improving image quality while in motion or low-light conditions.

### 10th Embodiment

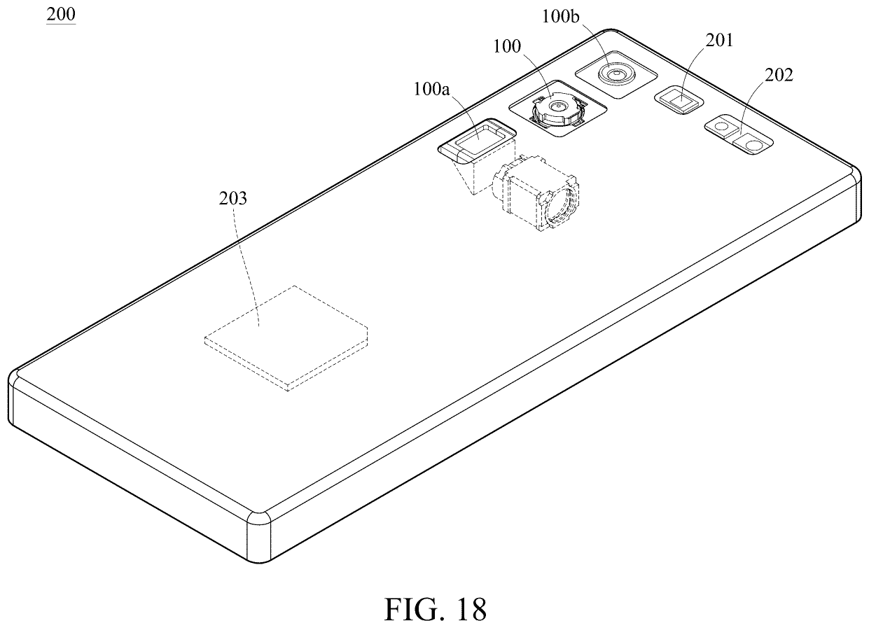

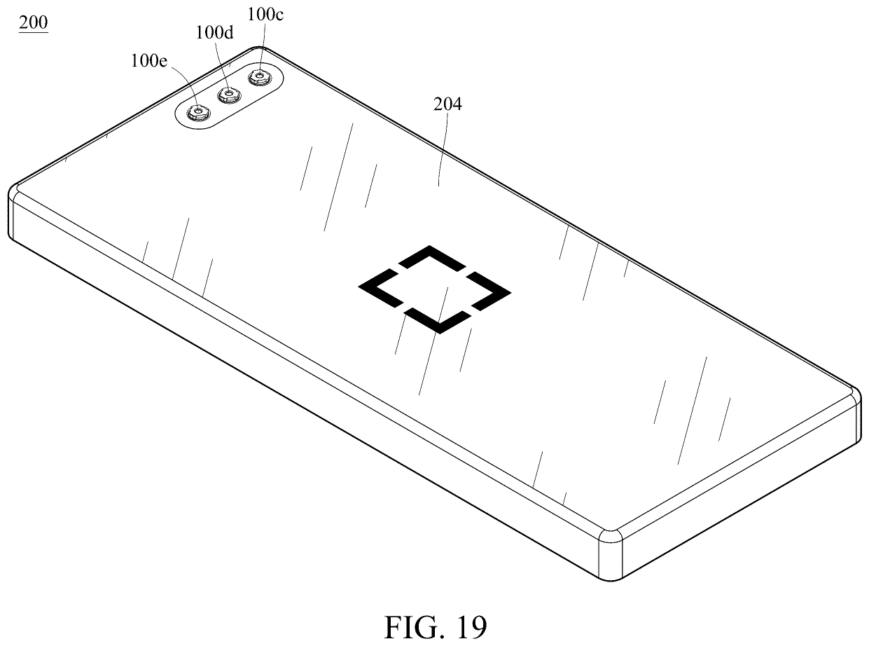

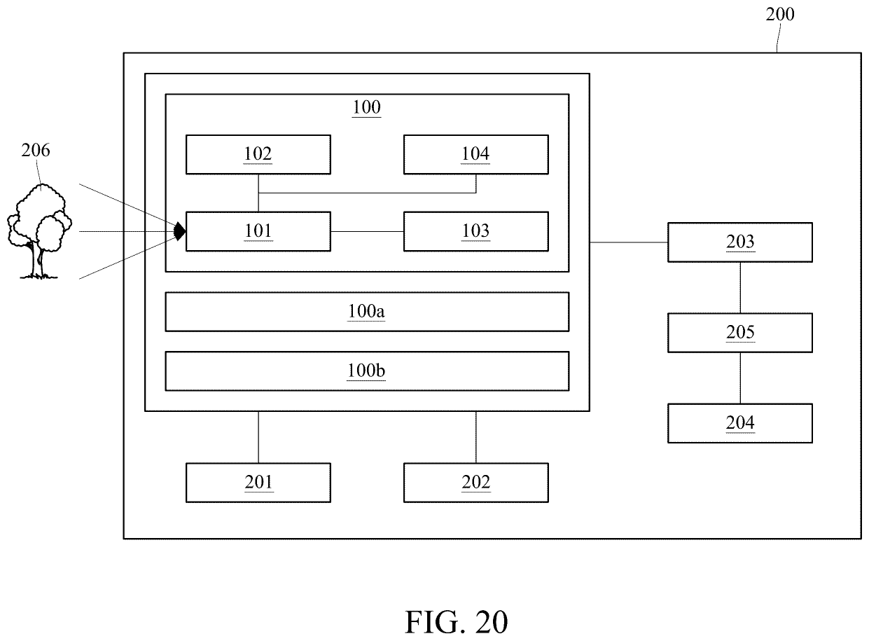

FIG. 18 is one perspective view of an electronic device according to the 13th embodiment of the present disclosure, FIG. 19 is another perspective view of the electronic device in FIG. 18, and FIG. 20 is a block diagram of the electronic device in FIG. 18.

In this embodiment, an electronic device 200 is a smartphone including the image capturing unit 100 as disclosed in the 9th embodiment, an image capturing unit 100a, an image capturing unit 100b, an image capturing unit 100c, an image capturing unit 100d, an image capturing unit 100e, a flash module 201, a focus assist module 202, an image signal processor 203, a display module 204 and an image software processor 205. The image capturing unit 100, the image capturing unit 100a and the image capturing unit 100b are disposed on the same side of the electronic device 200, and each of the image capturing units 100, 100a and 100b has a single focal point. The focus assist module 202 can be a laser rangefinder or a ToF (time of flight) module, but the present disclosure is not limited thereto. The image capturing unit 100c, the image capturing unit 100d, the image capturing unit 100e and the display module 204 are disposed on the opposite side of the electronic device 200, and the display module 204 can be a user interface, such that the image capturing units 100c, 100d and 100e can serve as front-facing cameras of the electronic device 200 for taking selfies, but the present disclosure is not limited thereto. Furthermore, each of the image capturing units 100a, 100b, 100c, 100d and 100e can include the optical system lens assembly of the present disclosure and can have a configuration similar to that of the image capturing unit 100. In detail, each of the image capturing units 100a, 100b, 100c, 100d and 100e can include a lens unit, a driving device, an image sensor and an image stabilizer, and can also include a light-folding element for folding optical path. In addition, each lens unit of the image capturing units 100a, 100b, 100c, 100d and 100e can include the optical system lens assembly of the present disclosure, a barrel and a holder member for holding the optical system lens assembly.

The image capturing unit 100 is a wide-angle image capturing unit, the image capturing unit 100a is a telephoto image capturing unit with optical path folding function, the image capturing unit 100b is an ultra-wide-angle image capturing unit, the image capturing unit 100c is a wide-angle image capturing unit, the image capturing unit 100d is an ultra-wide-angle image capturing unit, and the image capturing unit 100e is a ToF image capturing unit. In this embodiment, the image capturing units 100, 100a and 100b have different fields of view, such that the electronic device 200 can have various magnification ratios so as to meet the requirement of optical zoom functionality. In addition, the image capturing unit 100e can determine depth information of the imaged object. Moreover, the light-folding configuration of the image capturing unit 100a can be similar to, for example, one of the configurations as shown in FIG. 31 to FIG. 33, which can be referred to foregoing descriptions corresponding to FIG. 31 to FIG. 33, and the details in this regard will not be provided again. Moreover, each of the image capturing units 100, 100b, 100c, 100d and 100e can have a light-folding configuration similar to, for example, one of the configurations as shown in FIG. 31 to FIG. 33, which can be referred to foregoing descriptions corresponding to FIG. 31 to FIG. 33. In this embodiment, the electronic device 200 includes multiple image capturing units 100, 100a, 100b, 100c, 100d and 100e, but the present disclosure is not limited to the number and arrangement of image capturing units.

When a user captures images of an object 206, the light rays converge in the image capturing unit 100, the image capturing unit 100a or the image capturing unit 100b to generate images, and the flash module 201 is activated for light supplement. The focus assist module 202 detects the object distance of the imaged object 206 to achieve fast auto focusing. The image signal processor 203 is configured to optimize the captured image to improve image quality. The light beam emitted from the focus assist module 202 can be either conventional infrared or laser. In addition, the light rays may converge in the image capturing unit 100c, 100d or 100e to generate images. The display module 204 can include a touch screen, and the user is able to interact with the display module 204 and the image software processor 205 having multiple functions to capture images and complete image processing. Alternatively, the user may capture images via a physical button. The image processed by the image software processor 205 can be displayed on the display module 204.

### 11th Embodiment

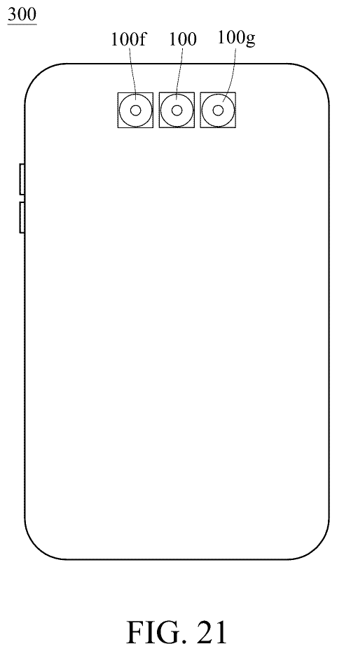

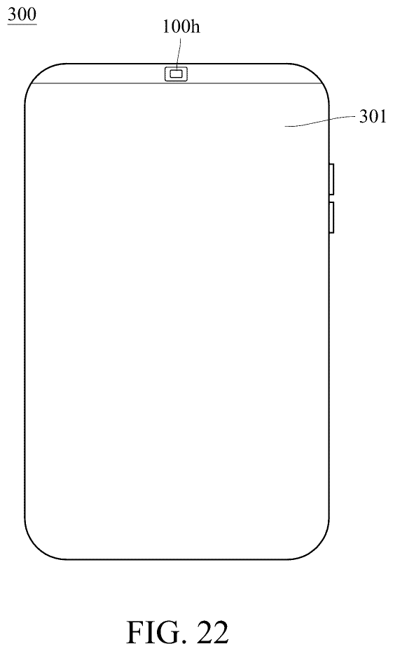

FIG. 21 is one schematic view of an electronic device according to the 11th embodiment of the present disclosure, and FIG. 22 is another schematic view of the electronic device in FIG. 21.

In this embodiment, an electronic device 300 is a smartphone including the image capturing unit 100 as disclosed in the 9th embodiment, an image capturing unit 100f, an image capturing unit 100g, an image capturing unit 100h and a display module 301. As shown in FIG. 21, the image capturing unit 100, the image capturing unit 100f and the image capturing unit 100g are disposed on the same side of the electronic device 300, and each of the image capturing units 100, 100f and 100g has a single focal point. As shown in FIG. 22, the image capturing unit 100h and the display module 301 are disposed on the opposite side of the electronic device 300, such that the image capturing unit 100h can serve as a front-facing camera of the electronic device 300 for taking selfies, but the present disclosure is not limited thereto. Furthermore, each of the image capturing units 100f, 100g and 100h can include the optical system lens assembly of the present disclosure and can have a configuration similar to that of the image capturing unit 100. In detail, each of the image capturing units 100f, 100g and 100h can include a lens unit, a driving device, an image sensor and an image stabilizer. In addition, each lens unit of the image capturing units 100f, 100g and 100h can include the optical system lens assembly of the present disclosure, a barrel and a holder member for holding the optical system lens assembly.

The image capturing unit 100 is a wide-angle image capturing unit, the image capturing unit 100f is a telephoto image capturing unit, the image capturing unit 100g is an ultra-wide-angle image capturing unit, and the image capturing unit 100h is a wide-angle image capturing unit. In this embodiment, the image capturing units 100, 100f and 100g have different fields of view, such that the electronic device 300 can have various magnification ratios so as to meet the requirement of optical zoom functionality. In this embodiment, the electronic device 300 includes multiple image capturing units 100, 100f, 100g and 100h, but the present disclosure is not limited to the number and arrangement of image capturing units.

### 12th Embodiment

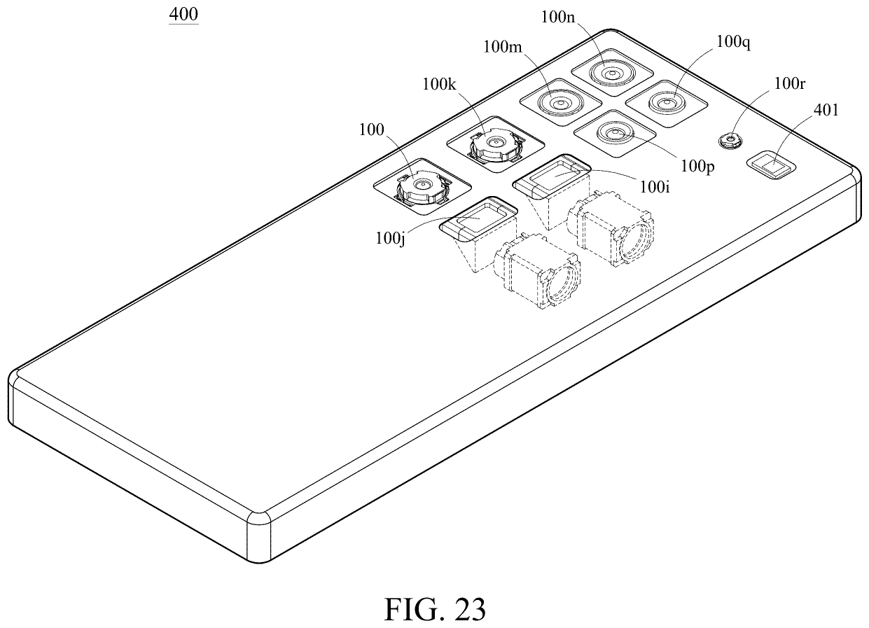

FIG. 23 is one perspective view of an electronic device according to the 12th embodiment of the present disclosure.

In this embodiment, an electronic device 400 is a smartphone including the image capturing unit 100 as disclosed in the 9th embodiment, an image capturing unit 100i, an image capturing unit 100j, an image capturing unit 100k, an image capturing unit 100m, an image capturing unit 100n, an image capturing unit 100p, an image capturing unit 100q, an image capturing unit 100r, a flash module 401, a focus assist module, an image signal processor, a display module and an image software processor (not shown). The image capturing units 100, 100i, 100j, 100k, 100m, 100n, 100p, 100q and 100r are disposed on the same side of the electronic device 400, while the display module is disposed on the opposite side of the electronic device 400. Furthermore, each of the image capturing units 100i, 100j, 100k, 100m, 100n, 100p, 100q and 100r can include the optical system lens assembly of the present disclosure and can have a configuration similar to that of the image capturing unit 100, and the details in this regard will not be provided again.

The image capturing unit 100 is a wide-angle image capturing unit, the image capturing unit 100i is a telephoto image capturing unit with optical path folding function, the image capturing unit 100j is a telephoto image capturing unit with optical path folding function, the image capturing unit 100k is a wide-angle image capturing unit, the image capturing unit 100m is an ultra-wide-angle image capturing unit, the image capturing unit 100n is an ultra-wide-angle telephoto image capturing unit, the image capturing unit 100p is a telephoto image capturing unit, the image capturing unit 100q is a telephoto image capturing unit, and the image capturing unit 100r is a ToF image capturing unit. In this embodiment, the image capturing units 100, 100i, 100j, 100k, 100m, 100n, 100p and 100q have different fields of view, such that the electronic device 400 can have various magnification ratios so as to meet the requirement of optical zoom functionality. In addition, the image capturing unit 100r can determine depth information of the imaged object. Moreover, the light-folding configuration of the image capturing units 100i and 100j can be similar to, for example, one of the structures shown in FIG. 31 to FIG. 33, which can be referred to foregoing descriptions corresponding to FIG. 31 to FIG. 33, and the details in this regard will not be provided again. In this embodiment, the electronic device 400 includes multiple image capturing units 100, 100i, 100j, 100k, 100m, 100n, 100p, 100q and 100r, but the present disclosure is not limited to the number and arrangement of image capturing units. When a user captures images of an object, the light rays converge in the image capturing unit 100, 100i, 100j, 100k, 100m, 100n, 100p, 100q or 100r to generate images, and the flash module 401 is activated for light supplement. Further, the subsequent processes are performed in a manner similar to the abovementioned embodiments, and the details in this regard will not be provided again.

### 13th Embodiment

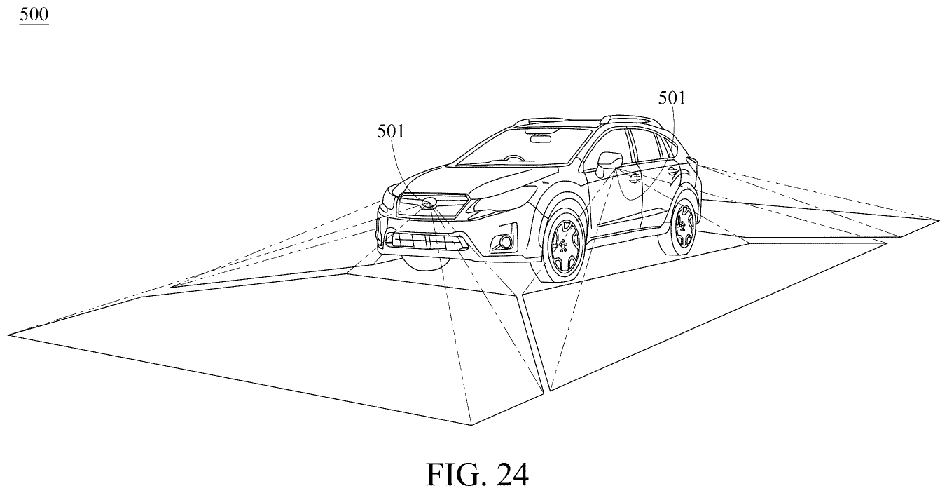

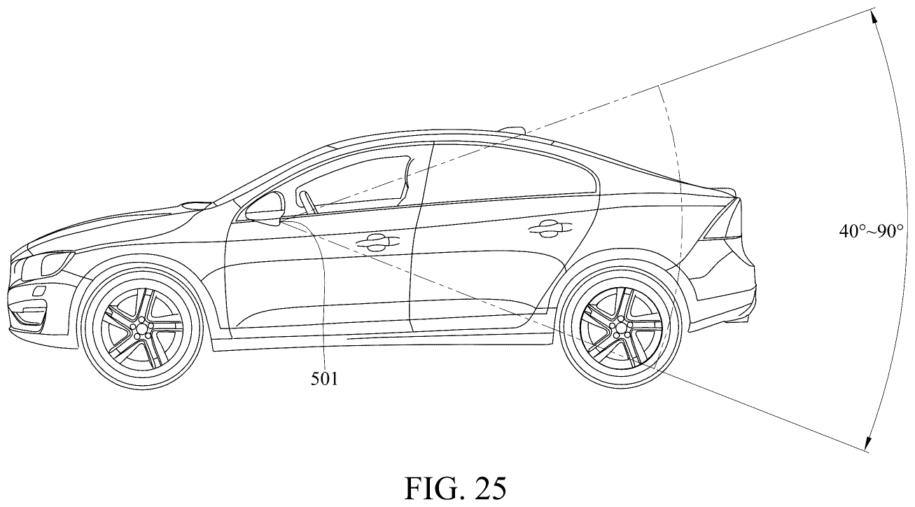

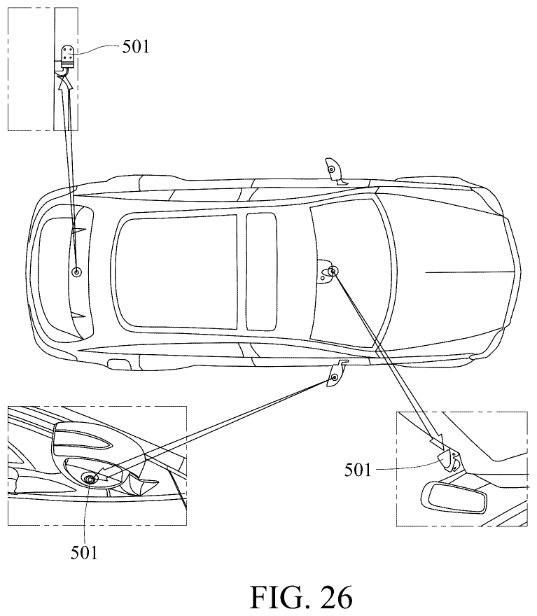

FIG. 24 is a perspective view of an electronic device according to the 13th embodiment of the present disclosure, FIG. 25 is a side view of the electronic device in FIG. 24, and FIG. 26 is a top view of the electronic device in FIG. 24.

In this embodiment, the electronic device 500 is a vehicle (e.g., an automobile). The electronic device 500 includes a plurality of image capturing units 501, and the image capturing units 501 each include the optical system lens assembly of the present disclosure. The image capturing units 501 can serve as, for example, panoramic view car cameras, dashboard cameras and vehicle backup cameras. The image capturing units 501 are, for example, wide-angle image capturing units.

As shown in FIG. 24 to FIG. 26, the image capturing units 501 are, for example, disposed at the front end, rear end, sides, rearview mirrors, and interior of the vehicle to capture images of the surrounding environment of the vehicle, which is favorable for recognizing external road conditions and thereby enables the implementation of automatic driver assistance functions. In addition, the images can be processed by an image software processor to create a panoramic view, providing the driver with images of blind spots, allowing the driver to monitor the surroundings of the vehicle, thereby favorable for driving and parking.

As shown in FIG. 25, the image capturing units 501 are, for example, respectively disposed on the lower portion of the side mirrors. A maximum field of view of the image capturing units 501 can be 40 degrees to 90 degrees for capturing images in regions on left and right lanes. As shown in FIG. 26, the image capturing units 501 can also be, for example, respectively disposed on the lower portion of the side mirrors and inside the front and rear windshields for providing external information to the driver, and also providing more viewing angles so as to reduce blind spots, thereby improving driving safety. The configuration and arrangement of the image capturing units shown in the figures is only exemplary. The number, position, and image capture direction of the image capturing units can be adjusted according to actual requirements.

### 14th Embodiment

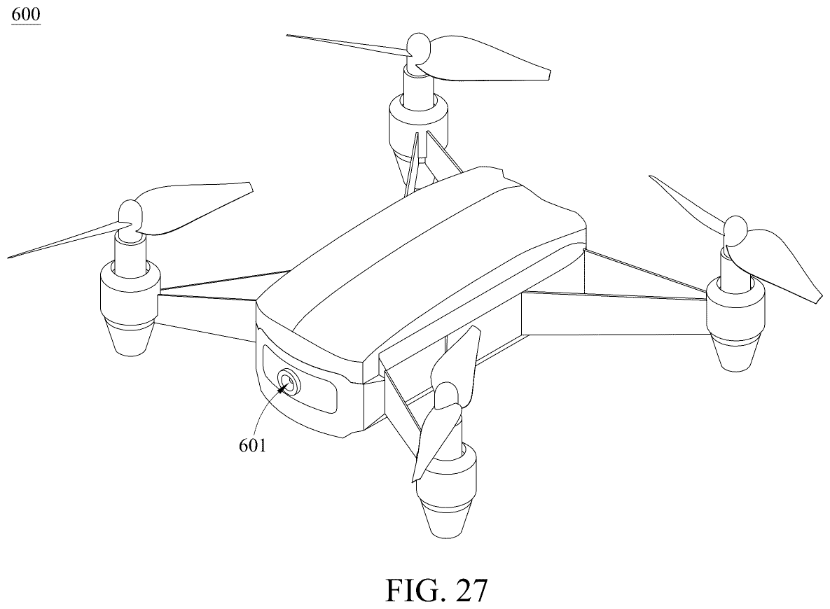

FIG. 27 is a perspective view of an electronic device according to the 14th embodiment of the present disclosure.

In this embodiment, an electronic device 600 is a lightweight unmanned aerial vehicle (e.g., a drone camera). The electronic device 600 includes an image capturing unit 601. The image capturing unit 601 includes the optical system lens assembly of the present disclosure, and the image capturing unit 601 can be a wide-angle image capturing unit. The image capturing unit 601, which is similar to the image capturing unit 100 as disclosed in the 9th embodiment, can further include a barrel, a holder member or a combination thereof. The electronic device 600 captures an image by the image capturing unit 601. Preferably, the electronic device may further include a control unit, a display unit, a storage unit, a random access memory unit (RAM) or a combination thereof. In this embodiment, the electronic device 600 includes a single image capturing unit 601 as exemplary, but the present disclosure is not limited to the number and arrangement of image capturing units.

The smartphones, vehicle, and unmanned aerial vehicle in the embodiments are only exemplary for showing the image capturing unit of the present disclosure installed in an electronic device, and the present disclosure is not limited thereto. The image capturing unit can be optionally applied to optical systems with a movable focus. Furthermore, the optical system lens assembly of the image capturing unit features good capability in aberration corrections and high image quality, and can be applied to 3D (three-dimensional) image capturing applications, in products such as digital cameras, mobile devices, digital tablets, smart televisions, network surveillance devices, dashboard cameras, vehicle backup cameras, multi-camera devices, image recognition systems, motion sensing input devices, wearable devices, portable video recorders, and other electronic imaging devices.

The foregoing description, for the purpose of explanation, has been described with reference to specific embodiments. It is to be noted that TABLES 1A-8C show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An optical system lens assembly comprising six lens elements, the six lens elements being, in order from an object side to an image side along an optical path, a first lens element, a second lens element, a third lens element, a fourth lens element, a fifth lens element and a sixth lens element, and each of the six lens elements having an object-side surface facing toward the object side and an image-side surface facing toward the image side;
wherein the first lens element has negative refractive power, the object-side surface of the second lens element is concave in a paraxial region thereof, the third lens element has positive refractive power, the fourth lens element has positive refractive power, the object-side surface of the fifth lens element is concave in a paraxial region thereof, and the sixth lens element has negative refractive power;
wherein a central thickness of the second lens element is CT2, and an axial distance between the first lens element and the second lens element is T12, and
using a wavelength of helium d-line as a reference wavelength for the optical system lens assembly, an Abbe number of the fifth lens element is V5d, an Abbe number of the sixth lens element is V6d, a focal length of the fifth lens element is f5d, a focal length of the sixth lens element is f6d, and the following conditions are satisfied:
$$20. < V 5 d + V 6 d < 65. ;$$
$$1.2 < CT 2 / T 12 < 4. ; and \vert f 6 d / f 5 d \vert < 3.5 .$$

2. The optical system lens assembly of claim 1, wherein using a wavelength of helium d-line as a reference wavelength for the optical system lens assembly, the Abbe number of the fifth lens element is V5d, the Abbe number of the sixth lens element is V6d, and the following condition is satisfied:
$$30. < V 5 d + V 6 d < 50. .$$

3. The optical system lens assembly of claim 1, wherein the central thickness of the second lens element is CT2, the axial distance between the first lens element and the second lens element is T12, and the following condition is satisfied:
$$1.4 < CT 2 / T 12 < 3. .$$

4. The optical system lens assembly of claim 1, wherein at least one of the object-side surface and the image-side surface of the sixth lens element has at least one critical point in an off-axis region thereof; and
wherein using a wavelength of helium d-line as a reference wavelength for the optical system lens assembly, the focal length of the fifth lens element is f5d, the focal length of the sixth lens element is f6d, and the following condition is satisfied:
$$0.05 < \vert f 6 d / f 5 d \vert < 2. .$$

5. The optical system lens assembly of claim 1, wherein the second lens element has positive refractive power, and the fifth lens element has positive refractive power.

6. The optical system lens assembly of claim 1, wherein using a wavelength of helium d-line as a reference wavelength for the optical system lens assembly, an axial distance between the object-side surface of the first lens element and an image surface is TLd, a focal length of the optical system lens assembly is fd, and the following condition is satisfied:
$$3. < TLd / fd < 5. .$$

7. The optical system lens assembly of claim 1, wherein a curvature radius of the object-side surface of the third lens element is R5, a curvature radius of the image-side surface of the third lens element is R6, and the following condition is satisfied:
$$- 0.5 < ( R 5 + R 6 ) / ( R 5 - R 6 ) < 1.5 .$$

8. The optical system lens assembly of claim 1, wherein a sum of axial distances between each of all adjacent lens elements of the optical system lens assembly is ΣAT, a sum of central thicknesses of all lens elements of the optical system lens assembly is ΣCT, and the following condition is satisfied:
$$0.05 < Σ AT / Σ CT < 0.45 .$$

9. The optical system lens assembly of claim 1, wherein a central thickness of the third lens element is CT3, a central thickness of the fifth lens element is CT5, and the following condition is satisfied:
$$0.8 < CT 5 / CT 3 < 2. .$$

10. The optical system lens assembly of claim 1, wherein the image-side surface of the third lens element is convex in a paraxial region thereof, and the image-side surface of the fifth lens element is convex in a paraxial region thereof; and
wherein using a wavelength of helium d-line as a reference wavelength for the optical system lens assembly, half of a maximum field of view of the optical system lens assembly is HFOVd, and the following condition is satisfied:
$$50. degrees < HFOVd < 75. degrees .$$

11. The optical system lens assembly of claim 1, wherein a maximum image height of the optical system lens assembly is ImgH; and
using a wavelength of helium d-line as a reference wavelength for the optical system lens assembly, a maximum effective radius of the object-side surface of the first lens element is Y1R1d, a maximum effective radius of the image-side surface of the third lens element is Y3R2d, and the following conditions are satisfied:
$$0.7 < Y 1 R 1 d / Y 3 R 2 d < 1.3 ; and 0.55 < Y 1 R 1 d / ImgH < 0.8 .$$

12. The optical system lens assembly of claim 1, wherein using a wavelength of helium d-line as a reference wavelength for the optical system lens assembly, a chief ray angle of a maximum field of view on an image surface of the optical system lens assembly is CRAd, and the following condition is satisfied:
$$5. degrees < CRAd < 25. degrees .$$

13. An image capturing unit comprising:
the optical system lens assembly of claim 1; and
an image sensor disposed on an image surface of the optical system lens assembly.

14. An electronic device comprising:
the image capturing unit of claim 13.

15. An optical system lens assembly comprising six lens elements, the six lens elements being, in order from an object side to an image side along an optical path, a first lens element, a second lens element, a third lens element, a fourth lens element, a fifth lens element and a sixth lens element, and each of the six lens elements having an object-side surface facing toward the object side and an image-side surface facing toward the image side;
wherein the first lens element has negative refractive power, the object-side surface of the second lens element is concave in a paraxial region thereof, the third lens element has positive refractive power, the fourth lens element has positive refractive power, the object-side surface of the fifth lens element is concave in a paraxial region thereof, the sixth lens element has negative refractive power, the object-side surface of the sixth lens element is convex in a paraxial region thereof, the image-side surface of the sixth lens element is concave in a paraxial region thereof, and at least one of the object-side surface and the image-side surface of the sixth lens element has at least one inflection point; and
wherein using a wavelength of helium d-line as a reference wavelength for the optical system lens assembly, an Abbe number of the first lens element is V1d, an Abbe number of the fifth lens element is V5d, an Abbe number of the sixth lens element is V6d, and the following conditions are satisfied:
$$20.2 < V 5 d + V 6 d < 55. ; and$$
$$10. < V 1 d < 35.0 .$$

16. The optical system lens assembly of claim 15, wherein using a wavelength of helium d-line as a reference wavelength for the optical system lens assembly, the Abbe number of the first lens element is V1d, and the following condition is satisfied:
$$13. < V 1 d < 30.0 .$$

17. The optical system lens assembly of claim 15, wherein a curvature radius of the object-side surface of the first lens element is R1, a curvature radius of the image-side surface of the sixth lens element is R12, and the following condition is satisfied:
$$0 < ( R 1 + R 12 ) / ( R 1 - R 12 ) < 2.50 .$$

18. The optical system lens assembly of claim 15, wherein using a wavelength of helium d-line as a reference wavelength for the optical system lens assembly, a focal length of the fourth lens element is f4d, a focal length of the sixth lens element is f6d, and the following condition is satisfied:
$$- 2.00 < f 4 d / f 6 d < - 0.15 .$$

19. The optical system lens assembly of claim 15, wherein a central thickness of the fourth lens element is CT4, a central thickness of the sixth lens element is CT6, and the following condition is satisfied:
$$2.5 < CT 4 / CT 6 < 6.50 .$$

20. The optical system lens assembly of claim 15, wherein a curvature radius of the object-side surface of the sixth lens element is R11, and a curvature radius of the image-side surface of the sixth lens element is R12; and
using a wavelength of helium d-line as a reference wavelength for the optical system lens assembly, a focal length of the optical system lens assembly is fd, and the following condition is satisfied:
$$1. 00 < fd / R 11 + fd / R 12 < 4.00 .$$

21. The optical system lens assembly of claim 15, further comprising an aperture stop, wherein an axial distance between the aperture stop and the image-side surface of the sixth lens element is SD, an axial distance between the object-side surface of the first lens element and the image-side surface of the sixth lens element is TD, and the following condition is satisfied:
$$0.75 < SD / TD < 1.1 .$$

22. An optical system lens assembly comprising six lens elements, the six lens elements being, in order from an object side to an image side along an optical path, a first lens element, a second lens element, a third lens element, a fourth lens element, a fifth lens element and a sixth lens element, and each of the six lens elements having an object-side surface facing toward the object side and an image-side surface facing toward the image side;
wherein the first lens element has negative refractive power, the object-side surface of the second lens element is concave in a paraxial region thereof, the third lens element has positive refractive power, the image-side surface of the third lens element is convex in a paraxial region thereof, the fourth lens element has positive refractive power, the object-side surface of the fifth lens element is concave in a paraxial region thereof, the sixth lens element has negative refractive power, the object-side surface of the sixth lens element is convex in a paraxial region thereof, the image-side surface of the sixth lens element is concave in a paraxial region thereof, and at least one of the object-side surface and the image-side surface of the sixth lens element has at least one inflection point;
wherein a maximum among axial distances between each of all adjacent lens elements of the optical system lens assembly is MaxAT, and a central thickness of the fifth lens element is CT5; and
using a wavelength of helium d-line as a reference wavelength for the optical system lens assembly, an Abbe number of the fifth lens element is V5d, an Abbe number of the sixth lens element is V6d, and the following conditions are satisfied:
$$20. < V 5 d + V 6 d < 70. ; and$$
$$0.1 < Max AT / CT 5 < 1.4 .$$

23. The optical system lens assembly of claim 22, wherein the maximum among axial distances between each of all adjacent lens elements of the optical system lens assembly is MaxAT, the central thickness of the fifth lens element is CT5, and the following condition is satisfied:
$$0.2 < Max AT / CT 5 < 1.25 .$$

24. The optical system lens assembly of claim 22, wherein using a wavelength of helium d-line as a reference wavelength for the optical system lens assembly, a focal length of the optical system lens assembly is fd, a focal length of the fifth lens element is f5d, and the following condition is satisfied:
$$- 0.45 < fd / f 5 d < 0.70 .$$

25. The optical system lens assembly of claim 22, wherein at least one of the six lens elements of the optical system lens assembly is made of glass material;
wherein a maximum image height of the optical system lens assembly is ImgH; and
using a wavelength of helium d-line as a reference wavelength for the optical system lens assembly, an axial distance between the object-side surface of the first lens element and an image surface is TLd, and the following condition is satisfied:
$$2.8 < TLd / ImgH < 5. .$$

26. The optical system lens assembly of claim 22, wherein the image-side surface of the fifth lens element is convex in a paraxial region thereof; and
wherein a central thickness of the first lens element is CT1, a central thickness of the second lens element is CT2, and the following condition is satisfied:
$$0.05 < CT 1 / CT 2 < 1. .$$

27. The optical system lens assembly of claim 22, wherein a curvature radius of the object-side surface of the fourth lens element is R7, a curvature radius of the image-side surface of the fourth lens element is R8, and the following condition is satisfied:
$$- 0.60 < ( R 7 + R 8 ) / ( R 7 - R 8 ) < 0.35 .$$

28. The optical system lens assembly of claim 22, wherein using a wavelength of helium d-line as a reference wavelength for the optical system lens assembly, an Abbe number of the first lens element is V1d, an Abbe number of the second lens element is V2d, and the following condition is satisfied:
$$0.6 < V 2 d / V 1 d < 4.00 .$$

29. The optical system lens assembly of claim 22, wherein a central thickness of the second lens element is CT2, the central thickness of the fifth lens element is CT5, an axial distance between the first lens element and the second lens element is T12, and the maximum among axial distances between each of all adjacent lens elements of the optical system lens assembly is MaxAT; and
using a wavelength of helium d-line as a reference wavelength for the optical system lens assembly, an Abbe number of the first lens element is V1d, the Abbe number of the fifth lens element is V5d, the Abbe number of the sixth lens element is V6d, a focal length of the optical system lens assembly is fd, a focal length of the fifth lens element is f5d, a focal length of the sixth lens element is f6d, an axial distance between the object-side surface of the first lens element and an image surface is TLd, and the following conditions are satisfied:
$$35.8 \leq V 5 d + V 6 d \leq 45.2 ;$$
$$1.57 \leq CT 2 / T 12 \leq 2 \text{.32} ;$$
$$19.5 \leq \vert f 6 d / f 5 d \vert \leq 1.7 ;$$
$$19.5 \leq V 1 d \leq 25.7 ;$$
$$0.36 \leq Max AT / CT 5 \leq 122 ; and$$
$$3.61 \leq TLd / fd \leq 4. 12 .$$
